(19) United States
(12) Patent Application Publication
(10) Pub. No.: US 2026/0152650 A1
(43) Pub. Date: Jun. 4, 2026

(54) BUILD MATERIAL COMPOSITION AND THERMALLY CONDUCTIVE AGENT FOR THREE-DIMENSIONAL PRINTING

(71) Applicant: PERIDOT PRINT LLC, Palo Alto, CA (US)

(72) Inventors: Greg Scott Long, Corvallis, OR (US); Emre Hiro Discekici, San Diego, CA (US); Emily Levin, San Diego, CA (US); Shannon Reuben Woodruff, San Diego, CA (US)

(21) Appl. No.: 19/122,367

(22) PCT Filed: Oct. 28, 2022
(86) PCT No.: PCT/US2022/048202

§ 371 Date: Apr. 18, 2025

(51) Int. Cl. B29C 64/118; B29C 64/153; B29C 64/165; B29C 64/255

(52) U.S. Cl. CPC C09D 7/62; B33Y 70/10; C09D 7/67; C09D 7/68; C09D 17/001; C09D 17/004; C09D 175/04; C09K 5/14; C08K 3/04; C08K 2003/385; C08K 9/04; C08K 2201/001; C08K 2201/005; C08K 2201/011

(57) ABSTRACT

Examples of a build material composition and a thermally conductive agent for three-dimensional printing are disclosed. An example of the build material composition includes from about 90 wt % to about 99 wt % of thermoplastic polyurethane particles and from about 1 wt % to about 10 wt % of a thermally conductive filler, based on a total weight of the build material composition. An example of the thermally conductive agent includes an aqueous vehicle and from about 1 wt % active to about 10 wt % active of the thermally conductive filler, based on a total weight of the thermally conductive agent. In both examples, the thermally conductive filler is selected from cubic boron nitride and diamond-like carbon.

### BACKGROUND

Three-dimensional (3D) printing is an additive manufacturing process used to make 3D printed articles from a digital model. 3D printing generally involves the application of successive layers of print material, such as a build material, one or more agents, and/or other printing material(s) to create the final 3D printed article. This is unlike traditional machining processes, which often rely on the removal of material to create the final 3D article. 3D printing is often used in rapid product prototyping, mold generation, mold master generation, and short run manufacturing for mass personalization and customization of goods.

### BRIEF DESCRIPTION OF THE DRAWINGS

Features of examples of the present disclosure will become apparent by reference to the following detailed description and drawings, in which like reference numerals correspond to similar, though perhaps not identical components. For the save of brevity, reference numerals or features having a previously described function may or may not be described in connection with other drawings in which they appear.

FIG. 1 is a schematic diagram illustrating an example of a 3D printing method.

FIG. 2 is a schematic diagram illustrating another example of a 3D printing method.

FIG. 3 is an enlarged, schematic, cross-sectional view of a 3D printed article created by the 3D printing methods of FIGS. 1 and 2.

FIG. 4 is a bar graph showing the thermal conductivity (W/(m·K), Y-axis) determined at a plurality of temperatures of four samples of build material compositions including thermoplastic polyurethane and a thermally conductive filler and two samples of comparative build material compositions including thermoplastic polyurethane alone.

FIG. 5 is a graph showing the melting enthalpy (J/g, Y-axis) determined for all six samples.

FIG. 6 is a graph showing the crystallization enthalpy (J/g, Y-axis) determined for all six samples.

FIG. 7 is a graph showing the thermal window (° C., Y-axis) for all six samples.

FIG. 8 is a bar graph showing the Young's Modulus (MPa, Y-axis) for all six samples.

FIG. 9 is a bar graph showing the Elongation at Break (%, Y-axis) for all six samples.

FIG. 10 is a bar graph showing the heat capacity (J/g·C, Y-axis) determined at a plurality of temperatures of two samples of comparative build material compositions including polypropylene powder and a cubic boron nitride thermally conductive filler and one sample of comparative build material compositions including polypropylene powder alone.

FIG. 11 is a bar graph showing the heat capacity (J/g·C, Y-axis) determined at a plurality of temperatures of two samples of comparative build material compositions including polypropylene powder and a diamond-like carbon thermally conductive filler and one sample of comparative build material compositions including polypropylene powder alone.

### DETAILED DESCRIPTION

The performance of a 3D printing process or technique often relies, at least in part, on the thermal properties of the 3D printing material(s) that are used in the process. For instance, the time it takes to melt a polymer in a build material composition, the time to allow for sufficient fusion of the melted polymer, and the thermal transfer of heat to and from the patterned build material composition each play a role in the overall performance of the 3D printing process. One way of controlling the thermal properties of the 3D printing material involves reformulating the polymer of the build material composition. However, reformulation of the polymer can be inefficient, and is often limited by the capabilities of the reformulating process used. As such, control of the thermal properties of the 3D printing material(s) to improve the performance of the 3D printing process remains a challenge.

The inventors of the present disclosure have found that the thermal properties of the polymer of the build material composition can be controlled by introducing a thermally conductive filler, either with the polymer in the build material composition or to the build material composition during patterning. The presence of the filler improves the 3D printing performance without having to rely on the thermal properties of the polymer alone. As illustrated in the Example section below, improvements in terms of the operational thermal window, the melt and crystallization enthalpies, and the thermal conductivity are achieved with a build material composition including a thermoplastic polyurethane (TPU) polymer and a thermally conductive filler selected from cubic boron nitride and diamond-like carbon. The build material composition disclosed herein exhibits the improved thermal properties by inclusion of the thermally conductive filler without altering the chemistry of the thermoplastic polyurethane. In other words, the improved thermal properties are achieved without having to reformulate the polymer of the build material. In addition, the thermally conductive filler present in the build material composition does not adversely affect the mechanical properties of a 3D printed article or part.

The present disclosure provides two implementations, and several examples are provided for each of the two implementations. The first implementation (“Implementation 1”) includes a build material composition that contains the thermally conductive filler, as well as a 3D printing kit and a 3D printing method that includes or utilizes the build material composition. The second implementation (“Implementation 2”) includes a thermally conductive agent that contains the thermally conductive filler, as well as a 3D printing kit and a 3D printing method that includes or utilizes the thermally conductive agent. Implementation 1 will be described first and Implementation 2 will be described afterwards.

Throughout this disclosure, a weight percentage that is referred to as “wt % active” refers to the loading of an active component of a stock formulation that is present, for example, in the thermally conductive agent, a fusing agent, a detailing agent, etc. For example, a thermally conductive filler, such as cubic boron nitride, may be present in a water-based formulation (e.g., a stock solution or dispersion) before being incorporated into the vehicle of the thermally conductive agent. In this example, the wt % active of the cubic boron nitride accounts for the loading (as a weight percent) of the cubic boron nitride solids that are present in the thermally conductive agent, and does not account for the weight of the other components (e.g., water, etc.) that are present in the stock solution or dispersion with the cubic boron nitride solids. The term “wt %,” without the term active, refers to the loading of a 100% active component that does not include other non-active components therein.

### Implementation 1

In Implementation 1, the thermally conductive filler is incorporated into the build material composition. During 3D printing, the build material composition is patterned with a fusing agent and is exposed to electromagnetic radiation to initiate coalescence of the polymer in the build material composition.

### Build Material Composition

In Implementation 1, the build material composition for three-dimensional printing includes thermoplastic polyurethane particles present in an amount of from about 90 wt % to about 99 wt %, based on a total weight of the build material composition; and a thermally conductive filler present in an amount of from about 1 wt % to about 10 wt %, based on the total weight of the build material composition, the thermally conductive filler being selected from the group consisting of cubic boron nitride and diamond-like carbon.

The build material composition includes the thermoplastic polyurethane particles. Thermoplastic polyurethane is a block copolymer including alternating sequences of hard and soft segments, and is the reaction product of an isocyanate component and an isocyanate-reactive component.

The isocyanate component is selected from aliphatic, cycloaliphatic, and aromatic isocyanates. In an example, the isocyanate component is a diisocyanate, such as diphenylmethane diisocyanates (MDIs), polymeric diphenylmethane diisocyanates (PMDIs), toluene diisocyanates (TDIs), hexamethylene diisocyanates (HDIs), isophorone diisocyanates (IPDIs), and combinations thereof. The isocyanate component makes up each of the hard segments of the block copolymer. The hard segments are responsible for various physical properties of the thermoplastic polyurethane, including hardness, scratch resistance, and impact strength.

The isocyanate-reactive component is a polyol, such as diols, triols, and glycols. The polyol may be selected from aliphatic polyols, cycloaliphatic polyols, aromatic polyols, and heterocyclic polyols. Examples of suitable isocyanate-reactive components include polyether polyols and polyester polyols. The isocyanate-reactive component makes up each of the soft segments of the block copolymer. The soft segments are responsible for at least the flexibility and elastomeric characteristics of the thermoplastic polyurethane. It is the presence of the soft segments in the thermoplastic polyurethane that enables the 3D printed articles formed from the build material composition to be useful in products such as footwear, sports protection equipment, orthotics, orthopedic models, car interior components, various industrial tools, and molded fiber products such as protective packaging products, beverage containers, food service trays, and/or the like. Other similar products are also envisioned.

The thermoplastic polyurethane may be formed in the presence of a suitable catalyst and one or more additives, such as one or more cross-linking agents and/or chain extenders. The additive(s) may be introduced to the isocyanate component and/or the isocyanate-reactive component prior to combining the isocyanate component and the isocyanate-reactive component to form a reaction product. Alternatively, the additive(s) may be introduced, as a standalone component, after the isocyanate component and the isocyanate-reactive component have been combined.

In an example, the thermoplastic polyurethane particles have a particle size of from about 10 μm to about 200 μm. In another example, the thermoplastic polyurethane particles have a particle size of from about 50 μm to about 120 μm. In yet another example, the thermoplastic polyurethane particles have a particle size of from about 70 μm to about 90 μm.

As used herein, the term “particle size” refers to a value of the diameter of spherical particles, or in particles that are not spherical, can refer to a longest dimension of that particle. The particle size can be presented as a Gaussian distribution or a Gaussian-like distribution (or normal or normal-like distribution). Gaussian-like distributions are distribution curves that can appear Gaussian in their distribution curve shape, but which can be slightly skewed in one direction or the other (toward the smaller end or toward the larger end of the particle size distribution range). That being stated, an example Gaussian-like distribution of, for example, the thermoplastic polyurethane particles can be characterized using “D10,” “D50,” and “D90” particle size distribution values, where D10 refers to the particle size at the 10th percentile, D50 refers to the particle size at the 50th percentile, and D90 refers to the particle size at the 90th percentile. For instance, a D50 value of 80 μm means that 50% of the particles (by number or volume) have a particle size greater than 80 μm and 50% of the particles have a particle size less than 80 μm. Particle size distribution values may not be related to Gaussian distribution curves, but in one example of the present disclosure, the thermoplastic polyurethane particles can have a Gaussian distribution, or more typically a Gaussian-like distribution with offset peaks at about D50. In practice, true Gaussian distributions are not typically present, as some skewing can be present, but still, the Gaussian-like distribution can be considered to be “Gaussian” as used in practice.

In an example, the thermoplastic polyurethane particles are provided in the form of a thermoplastic polyurethane powder. An example of a suitable thermoplastic polyurethane powder is ULTRASINT® TPU01 available from BASF Corporation (Florham Park, New Jersey).

The thermoplastic polyurethane particles may have a melting range of from about 120° C. to about 150° C. Other types of thermoplastic polyurethane particles may have a melting range of from about 130° C. to about 250° C.

The build material composition further includes the thermally conductive filler. As previously mentioned, the thermally conductive filler is incorporated into the build material composition to improve the thermal properties (e.g., the thermal conductivity) of the thermoplastic polyurethane. The improvement in the thermal properties is achieved without altering the chemistry of (e.g., reformulating) the thermoplastic polyurethane. Additionally, the thermally conductive filler does not adversely affect the mechanical properties of the 3D printed article, which has been created by a 3D printing method utilizing the build material composition (described in detail below). In an example, the thermally conductive filler is selected from the group consisting of cubic boron nitride and diamond-like carbon.

Cubic boron nitride (c-BN) is an allotropic crystalline form of boron nitride and has a sphalerite crystal structure similar to diamond. Cubic boron nitride is one of the hardest (in terms of material property) materials available, second to diamond, and is the most stable among the various allotropes of boron nitride. In addition, the thermal and chemical stability of cubic boron nitride is superior to that of diamond.

Cubic boron nitride may be obtained naturally or it may be synthesized. If synthesized, cubic boron nitride may be formed by treating hexagonal boron nitride (h-BN) at high temperature (e.g., from about 1730° C. to about 3230° C.) and high pressure (e.g., from about 5 GPa to about 18 GPa), similar to the synthesis used to produce synthetic diamond from graphite. In some instances, a catalyst may be used.

Diamond-like carbon (DLC) is an amorphous carbon material having a hexagonal layered chemical structure similar to that of graphite, except that diamond-like carbon has higher amounts of sp³ bonding and lower amounts of sp² bonding. Diamond-like carbon may be synthesized from graphite or other carbon-based materials, CₓH_{y}, using a variety of synthesis techniques.

Additionally, diamond-like carbon has material properties that are similar to diamond. For example, the density of diamond-like carbon has been measured to be about 3 g/cm³, while the density of diamond has been measured to be about 3.52 g/cm³. In another example, the hardness of diamond-like carbon has been measured (using a nano-indentation method under loads of less than 1 N for thin films of thickness of less than 1 μm) to be from about 10 GPa to about 90 GPa, while the hardness of diamond has been measured (using the same nano-indentation method) to be from about 90 GPa to about 100 GPa. It should be understood that the hardness of diamond-like carbon may vary depending, at least in part, on the ratio of sp³ and sp² bonding and the amount of hydrogen present in the chemical structure.

In an example, the thermally conductive filler (either the cubic boron nitride or the diamond-like carbon) is in solid form. The solid form may be a powder including nanoparticles of cubic boron nitride or diamond-like carbon. As such, the thermally conductive filler is, in some examples, further defined as thermally conductive nanoparticles. Nanoparticles (i.e., particle size ranging from 1 nm to less than 1 μm) are desirable, in part, because they are at least one order of magnitude smaller than the thermoplastic polyurethane particles and thus are minimally or non-disruptive to the blend with the thermoplastic polyurethane particles.

In instances where the thermally conductive nanoparticles are cubic boron nitride nanoparticles, the cubic boron nitride nanoparticles have, for example, a particle size of from about 70 nm to about 800 nm. In another example, the cubic boron nitride nanoparticles have a particle size of from about 100 nm to about 500 nm. In instances where the thermally conductive nanoparticles are diamond-like carbon nanoparticles, the diamond-like carbon nanoparticles have, for example, a particle size of from about 80 nm to about 600 nm. In another example, the diamond-like carbon nanoparticles have a particle size of from about 100 nm to about 250 nm.

As mentioned above, the build material composition comprises or includes the thermoplastic polyurethane particles and the thermally conductive filler. In an example, the build material composition consists of the thermoplastic polyurethane and the thermally conductive filler. In this particular example, the build material composition is free of any additional components. As such, in this example, the total weight of the build material composition is made up of the thermoplastic polyurethane particles and the thermally conductive filler.

In other examples, however, the build material composition may include one or more additives, such as an antioxidant, a whitener, an antistatic agent, a flow aid, or a combination thereof. While several examples of these additives are provided, it is to be understood that these additives are selected to be thermally stable (i.e., will not decompose) at the 3D printing temperatures.

Antioxidant(s) may be added to the build material composition to prevent or slow molecular weight decreases of the thermoplastic polyurethane particles and/or to prevent or slow discoloration (e.g., yellowing) of the thermoplastic polyurethane particles by preventing or slowing its oxidation. In some examples, the thermoplastic polyurethane particles may discolor upon reacting with oxygen, and this discoloration may contribute to the discoloration of the build material composition. The antioxidant may be selected to minimize discoloration. In some examples, the antioxidant may be a radical scavenger. In these examples, the antioxidant may include IRGANOX®1098 (benzenepropanamide, N,N′-1,6-hexanediylbis(3,5-bis(1,1-dimethylethyl)-4-hydroxy)), IRGANOX®254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less). In an example, the antioxidant may be included in the build material composition in an amount ranging from about 0.01 wt % to about 5 wt %, based on the total weight of the build material composition. In other examples, the antioxidant may be included in the build material composition in an amount ranging from about 0.01 wt % to about 2 wt % or from about 0.2 wt % to about 1 wt %, based on the total weight of the build material composition.

Whitener(s) may be added to the build material composition to bring the L* of the build material composition closer to 100 (white) and/or to improve visibility. Examples of suitable whiteners include titanium dioxide (TiO₂), zinc oxide (ZnO), calcium carbonate (CaCO₃), zirconium dioxide (ZrO₂), aluminum oxide (Al₂O₃), silicon dioxide (SiO₂), boron nitride (BN), and combinations thereof. In some examples, a stilbene derivative may be used as the whitener and a brightener. In these examples, the temperature(s) of the 3D printing process may be selected so that the stilbene derivative remains stable (i.e., the 3D printing temperature does not thermally decompose the stilbene derivative). Any example of the whitener may be included in the build material composition in an amount ranging from greater than 0 wt % to about 10 wt %, based on the total weight of the build material composition.

Antistatic agent(s) may be added to the build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the antistatic agent is added in an amount ranging from greater than 0 wt % to less than 5 wt %, based upon the total weight of the build material composition.

Flow aid(s) may be added to improve the coating flowability of the build material composition. Flow aids may be particularly beneficial when the build material composition has an average particle size less than 25 μm. The flow aid improves the flowability of the build material composition by reducing the friction, the lateral drag, and the tribocharge buildup (by increasing the particle conductivity). Examples of suitable flow aids include aluminum oxide (Al₂O₃), tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900). In an example, the flow aid is added in an amount ranging from greater than 0 wt % to less than 5 wt %, based upon the total weight of the build material composition.

As mentioned above, the thermoplastic polyurethane particles are provided in the form of micron-sized particles and the thermally conductive filler is provided in the form of nano-sized particles, and thus each of these components is in powder form. The powders are combined to form a dry blend of the thermoplastic polyurethane particles and the thermally conductive filler. In one example, the thermally conductive filler includes thermally conductive nanoparticles, and the build material composition is a dry blend of the thermoplastic polyurethane particles and the thermally conductive nanoparticles. The dry blend may be formed by mixing, such as in a mixer or blender suitable for combining dry components, the dry thermoplastic polyurethane particles (or powder) and the dry thermally conductive filler (or powder). In an example, the dry blend is a homogeneous mixture of the thermoplastic polyurethane particles and the thermally conductive filler. It should be understood that the term “dry blend” may be used interchangeably with the term “powder blend.” In addition, as a dry blend or a powder blend, the build material composition is considered to be a solid.

When one or more of the additives set forth herein for the build material composition are used, the additive(s) are dry blended with the thermoplastic polyurethane particles and the thermally conductive filler.

In any of the example build material compositions for Implementation 1, the thermoplastic polyurethane particles are present in the build material composition, for example, in an amount above 85 wt %, based on a total weight of the build material composition. In another example, the thermoplastic polyurethane particles are present in an amount of from about 90 wt % to about 99 wt %, based on the total weight of the build material composition. In yet another example, the thermoplastic polyurethane particles are present in an amount of from about 94 wt % to about 96 wt %, based on the total weight of the build material composition. In one particular example, the thermoplastic polyurethane is present in an amount of about 95 wt %, based on the total weight of the build material composition.

In any of the example build material compositions for Implementation 1, the thermally conductive filler is present in the build material composition, for example, in an amount up to about 15 wt %, based on the total weight of the build material composition. In another example, the thermally conductive filler is present in an amount of from about 1 wt % to about 10 wt %, based on the total weight of the build material composition. In still another example, the thermally conductive filler is present in an amount of from about 4 wt % to about 6 wt %, based on the total weight of the build material composition. In a particular example, the thermally conductive filler is present in an amount of about 5 wt %, based on the total weight of the build material composition. It should be understood that it is undesirable to include the thermally conductive filler in an amount above or higher than 15 wt %, based on the total weight of the build material composition. Higher thermally conductive filler loadings may have a greater impact on the ability to fuse, and thus can impact the parameters used in the 3D printing process. By controlling the thermal conductivity of the build material composition using the thermally conductive filler set forth herein, the printing parameters may be simplified (e.g., shorter fusing times, lower fusing power, etc.) and thus the process may be improved.

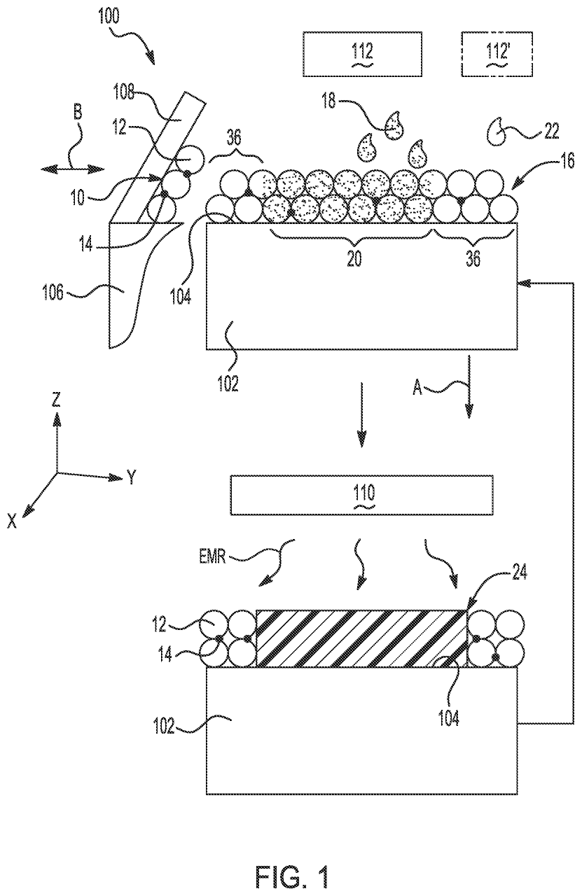

The build material composition described in reference to Implementation 1 may be used in a 3D printing method. A 3D printing system 100, such as that shown in FIG. 1, may be used to realize the 3D printing method. The method may involve selectively applying (according to a 3D digital model for the 3D printed article being formed) a fusing agent to pattern a build material layer formed from the build material composition, and exposing the entire patterned layer to electromagnetic radiation. In this method, the patterned region (which, in some instances, is less than the entire layer) of the build material composition coalesces and solidifies to become a layer of the 3D printed article. The fusing agents that can be used in this printing method will now be described.

### Fusing Agents

A variety of fusing agents may be used in the 3D printing method, each of which includes an energy absorber. In some examples, the energy absorber exhibits absorption at least at some wavelengths within a range of from 100 nm to 4000 nm. Unless stated otherwise, the term “absorption” means that 80% or more of the applied radiation having wavelengths within the specified range is absorbed by the energy absorber. Also unless stated otherwise, the term “transparency” means that 25% or less of the applied radiation having wavelengths within the specified range is absorbed by the energy absorber. Several examples of suitable fusing agents are described below.

### Fusing Agent #1

One example of a fusing agent (“Fusing Agent #1”) is referred to as a core fusing agent, and the energy absorber in the core fusing agent has absorption at least at wavelengths of from 400 nm to 780 nm (e.g., in the visible region). The energy absorber in the core fusing agent may also absorb energy in the infrared region (e.g., from 800 nm to 4000 nm). During 3D printing, the absorption of the energy absorber generates heat suitable for coalescing/fusing the build material composition in contact therewith, which leads to 3D printed articles having mechanical integrity and relatively uniform mechanical properties (e.g., strength, elongation at break, etc.). This absorption, however, also results in strongly colored, e.g., dark grey or black, 3D printed articles (or 3D printed article regions).

Examples of the energy absorber in the core fusing agent may be an infrared light absorbing colorant. In an example, the energy absorber is a near-infrared light absorbing colorant. Any near-infrared colorants, e.g., those produced by Fabricolor Holding, Int'l LLC, Eastman Kodak Company, or BASF SE, Yamamoto Chemicals Inc., may be used in the core fusing agent. As one example, the core fusing agent may be a printing liquid formulation including carbon black as the energy absorber. Examples of this printing liquid formulation are commercially known as CM997A, 516458, C18928, C93848, C93808, or the like, all of which are available from HP Inc.

As another example, the core fusing agent may be a printing liquid formulation including near-infrared absorbing dyes as the active material. Examples of this printing liquid formulation are described in U.S. Pat. No. 9,133,344, which is incorporated herein by reference in its entirety. Some examples of the near-infrared absorbing dye are water-soluble near-infrared absorbing dyes selected from the group consisting of:

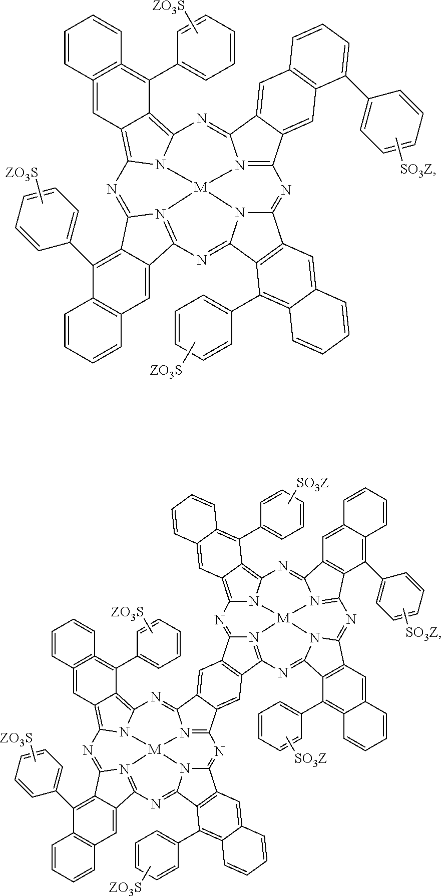

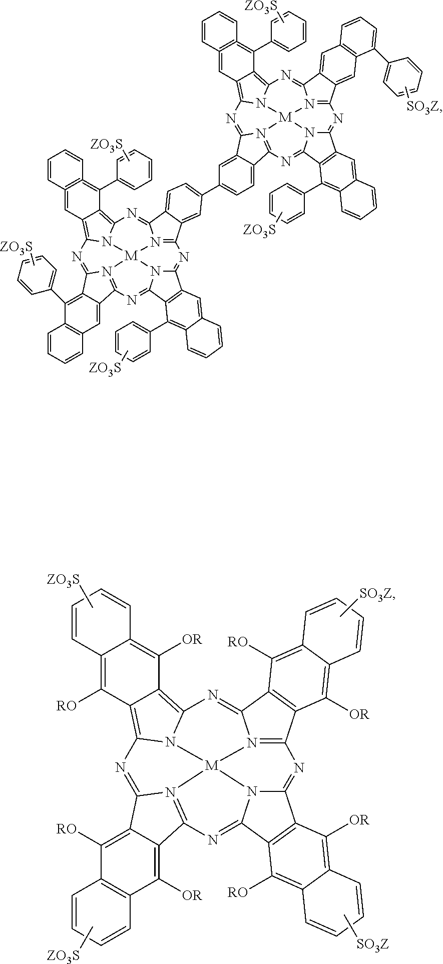

and mixtures thereof. In the above formulations, M can be a divalent metal atom (e.g., copper, etc.) or can have OSO₃Na axial groups filling any unfilled valencies if the metal is more than divalent (e.g., indium, etc.), R can be hydrogen or any C₁-C₈ alkyl group (including substituted alkyl and unsubstituted alkyl), and Z can be a counterion such that the overall charge of the near-infrared absorbing dye is neutral. For example, the counterion can be sodium, lithium, potassium, NH₄⁺, etc.

Some other examples of the near-infrared absorbing dye are hydrophobic near-infrared absorbing dyes selected from the group consisting of:

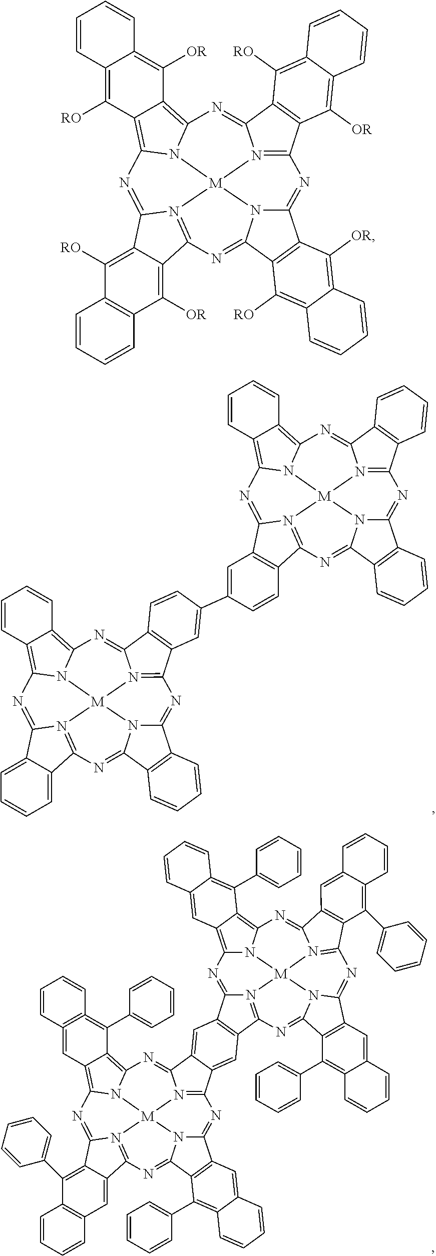

and mixtures thereof. For the hydrophobic near-infrared absorbing dyes, M can be a divalent metal atom (e.g., copper, etc.) or can include a metal that has Cl, Br, or OR′ (R′═H, CH₃, COCH₃, COCH₂COOCH₃, COCH₂COCH₃) axial groups filling any unfilled valencies if the metal is more than divalent, and R can be hydrogen or any C₁-C₈ alkyl group (including substituted alkyl and unsubstituted alkyl).

Other near-infrared absorbing dyes or pigments may be used in the core fusing agent. Some examples include anthraquinone dyes or pigments, metal dithiolene dyes or pigments, cyanine dyes or pigments, perylenediimide dyes or pigments, croconium dyes or pigments, pyrilium or thiopyrilium dyes or pigments, boron-dipyrromethene dyes or pigments, or aza-boron-dipyrromethene dyes or pigments.

Anthraquinone dyes or pigments and metal (e.g., nickel) dithiolene dyes or pigments may have the following structures, respectively:

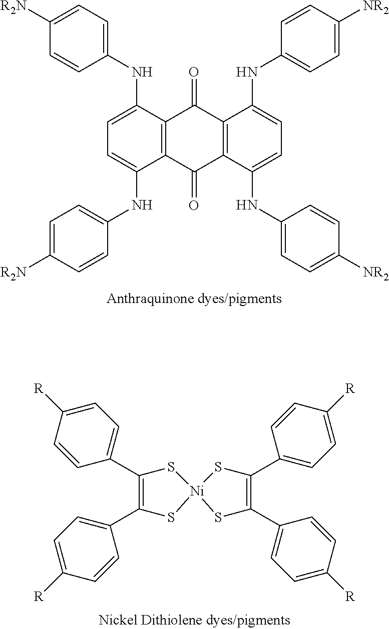

where R in the anthraquinone dyes or pigments may be hydrogen or any C₁-C₈ alkyl group (including substituted alkyl and unsubstituted alkyl), and R in the dithiolene may be hydrogen, COOH, SO₃, NH₂, any C₁-C₈ alkyl group (including substituted alkyl and unsubstituted alkyl), or the like.

Cyanine dyes or pigments and perylenediimide dyes or pigments may have the following structures, respectively:

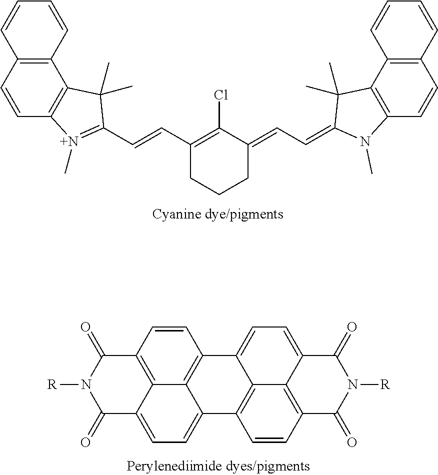

where R in the perylenediimide dyes or pigments may be hydrogen or any C₁-C₈ alkyl group (including substituted alkyl and unsubstituted alkyl).

Croconium dyes or pigments and pyrilium or thiopyrilium dyes or pigments may have the following structures, respectively:

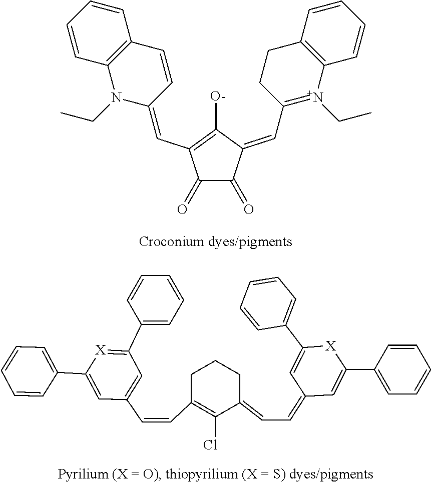

Boron-dipyrromethene dyes or pigments and aza-boron-dipyrromethene dyes or pigments may have the following structures, respectively:

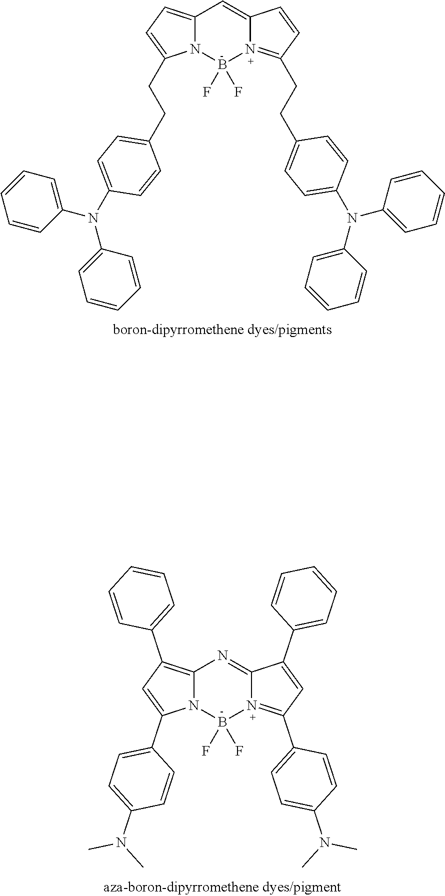

Other suitable near-infrared absorbing dyes may include aminium dyes, tetraaryldiamine dyes, phthalocyanine dyes, and others.

Other near infrared absorbing materials include conjugated polymers (i.e., a polymer that has a backbone with alternating double and single bonds), such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof.

The amount of the energy absorber that is present in the core fusing agent is from greater than 0 wt % active to about 40 wt % active, based on the total weight of the core fusing agent. In other examples, the amount of the active material in the core fusing agent is from about 0.3 wt % active to 30 wt % active, from about 1 wt % active to about 20 wt % active, from about 1.0 wt % active up to about 10.0 wt % active, or from greater than 4.0 wt % active up to about 15.0 wt % active. It is believed that these active material loadings provide a balance between the core fusing agent having jetting reliability and heat and/or radiation absorbance efficiency.

### Fusing Agent #2

Another example of the fusing agent (“Fusing Agent #2”) is referred to herein as a primer fusing agent or a low tint fusing agent, and the energy absorber in the primer fusing agent is a plasmonic resonance absorber having absorption at wavelengths of from 100 nm to 400 nm or from 800 nm to 4000 nm and having transparency at wavelengths of from 400 nm to 780 nm. This absorption and transparency allow the primer fusing agent to absorb enough radiation to coalesce/fuse the build material composition in contact therewith, while enabling the 3D printed article (or 3D printed article regions) to be white or slightly colored.

Some examples of the primer fusing agent are dispersions including the energy absorber that has absorption at wavelengths of from 800 nm to 4000 nm and transparency at wavelengths of from 400 nm to 780 nm. The absorption of this energy absorber may be the result of plasmonic resonance effects. Electrons associated with the atoms of the energy absorber may be collectively excited by radiation, which results in collective oscillation of the electrons. The wavelengths that can excite and oscillate these electrons collectively are dependent on the number of electrons present in the energy absorber particles, which in turn is dependent on the size of the energy absorber particles. The amount of energy that can collectively oscillate the particle's electrons is low enough that very small particles (e.g., from 1 nm to 100 nm) may absorb radiation with wavelengths several times (e.g., from 8 to 800 or more times) the size of the particles. The use of these particles allows the primer fusing agent to be inkjet jettable as well as electromagnetically selective (e.g., having absorption at wavelengths of from 800 nm to 4000 nm and transparency at wavelengths of from 400 nm to 780 nm).

In an example, the energy absorber of the primer fusing agent has an average particle size of from greater than 0 nm to less than 220 nm. In another example, the energy absorber has an average particle size of from greater than 0 nm to 120 nm. In a still another example, the energy absorber has an average particle size of from about 10 nm to about 200 nm.

In an example, the energy absorber of the primer fusing agent is an inorganic pigment. Examples of suitable inorganic pigments include lanthanum hexaboride (LaB₆), tungsten bronzes (AₓWO₃), indium tin oxide (In₂O₃:SnO₂, ITO), antimony tin oxide (Sb₂O₃:SnO₂, ATO), titanium nitride (TiN), aluminum zinc oxide (AZO), ruthenium oxide (RuO₂), iron pyroxenes (AₓFe_{y}Si₂O₆ wherein A is Ca or Mg, x=1.5-1.9, and y=0.1-0.5), modified iron phosphates (AₓFe_{y}PO₄), modified copper phosphates (AₓCu_{y}PO_{z}), and modified copper pyrophosphates (AₓCu_{y}P₂O₇). Tungsten bronzes may be alkali doped tungsten oxides. Examples of suitable alkali dopants (i.e., A in AₓWO₃) may be cesium, sodium, potassium, or rubidium. In an example, the alkali doped tungsten oxide may be doped in an amount of from greater than 0 mol % to about 0.33 mol % based on the total mol % of the alkali doped tungsten oxide. Suitable modified iron phosphates (AₓFe_{y}PO) may include copper iron phosphate (A=Cu, x=0.1-0.5, and y=0.5-0.9), magnesium iron phosphate (A=Mg, x=0.1-0.5, and y=0.5-0.9), and zinc iron phosphate (A=Zn, x=0.1-0.5, and y=0.5-0.9). For the modified iron phosphates, it is to be understood that the number of phosphates may change based on the charge balance with the cations. Suitable modified copper pyrophosphates (AₓCu_{y}P₂O₇) include iron copper pyrophosphate (A=Fe, x=0-2, and y=0-2), magnesium copper pyrophosphate (A=Mg, x=0-2, and y=0-2), and zinc copper pyrophosphate (A=Zn, x=0-2, and y=0-2). Combinations of the inorganic pigments may also be used.

The amount of the energy absorber that is present in the primer fusing agent is from greater than 0 wt % active to about 40 wt % active, based on the total weight of the primer fusing agent. In other examples, the amount of the energy absorber in the primer fusing agent is from about 0.3 wt % active to 30 wt % active, from about 1 wt % active to about 20 wt % active, from about 1.0 wt % active up to about 10.0 wt % active, or from greater than 4.0 wt % active up to about 15.0 wt % active. It is believed that these energy absorber loadings provide a balance between the primer fusing agent having jetting reliability and heat and/or radiation absorbance efficiency.

The energy absorber of the primer fusing agent may, in some instances, be dispersed with a dispersant. As such, the dispersant helps to uniformly distribute the energy absorber throughout the primer fusing agent. Examples of suitable dispersants include polymer or small molecule dispersants, charged groups attached to the energy absorber surface, or other suitable dispersants. Some specific examples of suitable dispersants include a water-soluble acrylic acid polymer (e.g., CARBOSPERSE® K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL®690, etc. available from BASF Corp.), a high molecular weight block copolymer with pigment affinic groups (e.g., DISPERBYK®-190 available BYK Additives and Instruments), or water-soluble styrene-maleic anhydride copolymers/resins.

Whether a single dispersant is used or a combination of dispersants is used, the total amount of dispersant(s) in the primer fusing agent may be from about 10% to about 200% of the weight of the energy absorber in the primer fusing agent. For example, if the energy absorber makes up 20 wt % of the fusing agent, the dispersant may range from about 2 wt % active (i.e., 10% of the 20 wt %) to about 40 wt % active (i.e., 200% of the 20%).

A silane coupling agent may also be added to the primer fusing agent to help bond the organic (e.g., dispersant) and inorganic (e.g., pigment) materials. Examples of suitable silane coupling agents include those of the SILQUEST® A series manufactured by Momentive.

Whether a single silane coupling agent is used or a combination of silane coupling agents is used, the total amount of silane coupling agent(s) in the primer fusing agent may be from about 0.1 wt % active to about 50 wt % active, based on the weight of the energy absorber in the primer fusing agent. In an example, the total amount of silane coupling agent(s) in the primer fusing agent is from about 1 wt % active to about 30 wt % active, based on the weight of the energy absorber. In another example, the total amount of silane coupling agent(s) in the primer fusing agent is from about 2.5 wt % active to about 25 wt % active, based on the weight of the energy absorber.

One example of the primer fusing agent includes cesium tungsten oxide (CTO) nanoparticles as the energy absorber. The CTO nanoparticles have a formula of CsₓWO₃, where 0<x<1. The cesium tungsten oxide nanoparticles may give the primer fusing agent a light blue color. The strength of the color may depend, at least in part, on the amount of the CTO nanoparticles in the primer fusing agent. When it is desirable to form an outer white layer on the 3D printed object, less of the CTO nanoparticles may be used in the primer fusing agent in order to achieve the white color. In an example, the CTO nanoparticles may be present in the primer fusing agent in an amount of from about 1 wt % active to about 20 wt % active, based on the total weight of the primer fusing agent.

The average particle size of the CTO nanoparticles may be from about 1 nm to about 40 nm. In some examples, the average particle size of the CTO nanoparticles may be from about 1 nm to about 15 nm or from about 1 nm to about 10 nm. The upper end of the particle size range (e.g., from about 30 nm to about 40 nm) may be less desirable, as these particles may be more difficult to stabilize.

This example of the primer fusing agent may also include a zwitterionic stabilizer. The zwitterionic stabilizer may improve the stabilization of this example of the primer fusing agent. While the zwitterionic stabilizer has an overall neutral charge, at least one area of the molecule has a positive charge (e.g., amino groups) and at least one other area of the molecule has a negative charge. The CTO nanoparticles may have a slight negative charge. The zwitterionic stabilizer molecules may orient around the slightly negative CTO nanoparticles with the positive area of the zwitterionic stabilizer molecules closest to the CTO nanoparticles and the negative area of the zwitterionic stabilizer molecules furthest away from the CTO nanoparticles. Then, the negative charge of the negative area of the zwitterionic stabilizer molecules may repel CTO nanoparticles from each other. The zwitterionic stabilizer molecules may form a protective layer around the CTO nanoparticles, and prevent them from coming into direct contact with each other and/or increase the distance between the particle surfaces (e.g., by a distance of from about 1 nm to about 2 nm). Thus, the zwitterionic stabilizer may prevent the CTO nanoparticles from agglomerating and/or settling in the primer fusing agent.

Examples of suitable zwitterionic stabilizers include C₂ to C₈ betaines, C₂ to C₈ aminocarboxylic acids having a solubility of at least 10 g in 100 g of water, taurine, and combinations thereof. Examples of the C₂ to C₈ aminocarboxylic acids include beta-alanine, gamma-aminobutyric acid, glycine, and combinations thereof.

The zwitterionic stabilizer may be present in the primer fusing agent in an amount of from about 2 wt % active to about 35 wt % active, based on the total weight of the primer fusing agent. When the zwitterionic stabilizer is the C₂ to C₈ betaine, the C₂ to C₈ betaine may be present in an amount of from about 8 wt % to about 35 wt % active of the total weight of the primer fusing agent. When the zwitterionic stabilizer is the C₂ to C₈ aminocarboxylic acid, the C₂ to C₈ aminocarboxylic acid may be present in an amount of from about 2 wt % active to about 20 wt % active of the total weight of the primer fusing agent. When the zwitterionic stabilizer is taurine, taurine may be present in an amount of from about 2 wt % active to about 35 wt % active of the total weight of the primer fusing agent.

In this example, the weight ratio of the CTO nanoparticles to the zwitterionic stabilizer may be from 1:10 to 10:1; or the weight ratio of the CTO nanoparticles to the zwitterionic stabilizer may be 1:1.

Fusing Agent #3

Still another example of the fusing agent (“Fusing Agent #3) is referred to herein as an ultraviolet (UV) light fusing agent, and the energy absorber in the UV fusing agent is a molecule or compound having absorption at wavelengths of from 100 nm to 400 nm. These energy absorbers efficiently absorb the UV radiation, convert the absorbed UV radiation to thermal energy, and promote the transfer of the thermal heat to build material composition in order to coalesce the build material composition.

The UV fusing agent can be used with a narrow-band emission source, such as UV light emitting diodes (LEDs), which reduces the band of photon energies to which the non-patterned build material is exposed and thus potentially absorbs. This can lead to more accurate object shapes and reduced rough edges. Some UV energy absorbers are substantially colorless and thus can generate much lighter (e.g., white, off-white, or even translucent) 3D objects than infrared (IR) and/or visible radiation absorbers.

Some examples of UV energy absorbers suitable for the UV fusing agent include a B vitamin and/or a B vitamin derivative. Any B vitamins and/or B vitamin derivatives that are water soluble and that have absorption at wavelengths of from about 340 nm to about 415 nm may be used in the UV light fusing agent. As used herein, the phrase “that has absorption at wavelengths of from about 340 nm to about 415 nm” means that the B vitamin or B vitamin derivative exhibits maximum absorption at a wavelength within the given range and/or has an absorbance of about 0.1 (about 80% transmittance or less) at one or more wavelengths within the given range. Some of the B vitamins or B vitamin derivatives have lower absorbance. These B vitamins or B vitamin derivatives can still result in suitable coalescence and fusing when they are coupled with a higher intensity and/or a higher dose (where dose=intensity*radiation time).

Examples of suitable B vitamins include riboflavin (vitamin B2), pantothenic acid (vitamin B5), pyridoxine (one form of vitamin B6), pyridoxamine (another form of vitamin B6), biotin (vitamin B7), folic acid (synthetic form of vitamin B9), cyanocobalamin (synthetic form of vitamin B12), and combinations thereof. Examples of suitable B vitamin derivatives include flavin mononucleotide, pyridoxal phosphate hydrate, pyridoxal hydrochloride, pyridoxine hydrochloride, and combinations thereof. Any combination of one or more B vitamins and one or more B vitamin derivatives may also be used. This may be desirable, for example, when one vitamin or vitamin derivative is less absorbing.

The amount of the B vitamin and/or B vitamin derivative present in the UV light fusing agent will depend, in part, upon its solubility in water and its effect on the jettability of the fusing agent. When solubility limit of the B vitamin and/or B vitamin derivative is low, the B vitamin and/or B vitamin derivative may be present in an amount of from about 1 wt % active to about 5 wt % active of the total weight of the fusing agent. For example, when the B vitamin or the B vitamin derivative is selected from the group consisting of riboflavin (solubility in water 1000 mg/3,000-15,000 mL depending on the crystal structure), folic acid (solubility in water 0.01 mg/mL), cyanocobalamin (solubility in water 1000 mg/80 mL), panthotenic acid (solubility in water 2110 mg/mL), biotin (solubility in water 0.22 mg/mL), pyridoxine (solubility in water ranging from 79 mg/mL to 220 mg/mL), and combinations thereof, the B vitamin or the B vitamin derivative is present in an amount of from about 1 wt % active to about 5 wt % active based on a total weight of the UV light fusing agent. When solubility limit of the B vitamin and/or B vitamin derivative is higher, the B vitamin and/or B vitamin derivative may be present in an amount of from about 1 wt % active to about 8 wt % active of the total weight of the fusing agent. For example, when the B vitamin or the B vitamin derivative is selected from the group consisting pyridoxal phosphate hydrate (solubility in water 5.7 mg/mL), pyridoxal hydrochloride (solubility in water 11.7 mg/mL), pyridoxine hydrochloride (solubility in water 200 mg/mL), pyridoxamine (solubility in water 29 mg/mL), and combinations thereof, the B vitamin or the B vitamin derivative may be present in an amount of from about 1 wt % active to about 8 wt % active, based on a total weight of the UV light fusing agent.

Another example of UV energy absorber is a functionalized benzophenone. Some of the functionalized benzophenones have absorption at wavelengths of from about 340 nm to 405 nm. The phrase “have absorption at wavelengths of from about 340 nm to about 405 nm” means that the functionalized benzophenone exhibits maximum absorption at a wavelength within the given range and/or has an absorbance of about 0.1 (about 80% transmittance or less) at one or more wavelengths within the given range.

The functionalized benzophenone is benzophenone substituted with at least one hydrophilic functional group. The functionalilzation may render the substituted benzophenone more hydrophilic than benzophenone and/or may shift the absorption of the substituted benzophenone to the desired UV range (from 340 nm to 405 nm). As such, the functionalized benzophenone is a benzophenone derivative including at least one hydrophilic functional group. In some examples, the functionalized benzophenone is benzophenone substituted with one hydrophilic functional group. In other examples, the functionalized benzophenone is benzophenone substituted with two hydrophilic functional groups. In still other examples, the functionalized benzophenone is benzophenone substituted with three hydrophilic functional groups. In the examples where the benzophenone is substituted with multiple functional groups, these groups may be the same or different. Examples of the hydrophilic functional group may be selected from the group consisting of an amine group, a hydroxy group, an alkoxy group, a carboxylic acid group, or a sulfonic acid group.

In examples where the at least one hydrophilic functional group is the amine group, the functionalized benzophenone is selected from the group consisting of 4-aminobenzophenone:

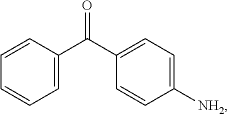 [SMILES: Nc1ccc(C(=O)c2ccccc2)cc1]

4-dimethylaminobenzophenone:

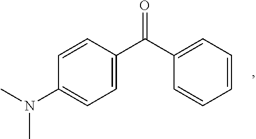 [SMILES: CN(C)c1ccc(C(=O)c2ccccc2)cc1]

and combinations thereof.

In examples where the at least one hydrophilic functional group is the hydroxy group, the functionalized benzophenone is selected from the group consisting of 4-hydroxy-benzophenone:

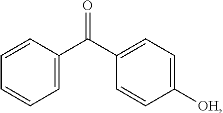 [SMILES: O=C(c1ccccc1)c1ccc(O)cc1]

2,4-dihydroxy-benzophenone:

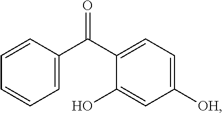 [SMILES: O=C(c1ccccc1)c1ccc(O)cc1O]

4,4-dihydroxy-benzophenone:

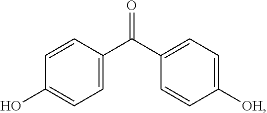 [SMILES: O=C(c1ccc(O)cc1)c1ccc(O)cc1]

2,4,4′-trihydroxy-benzophenone:

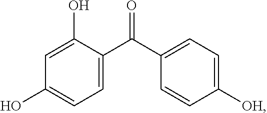 [SMILES: O=C(c1ccc(O)cc1)c1ccc(O)cc1O]

2,4,6-trihydroxy-benzophenone:

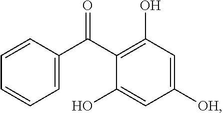 [SMILES: O=C(c1ccccc1)c1c(O)cc(O)cc1O]

2,2′,4,4′-tetrahydroxy-benzophenone:

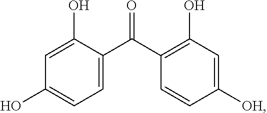 [SMILES: O=C(c1ccc(O)cc1O)c1ccc(O)cc1O]

2,3,4-trihydroxy-benzophenone:

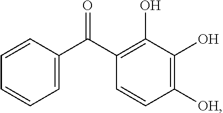 [SMILES: O=C(c1ccccc1)c1ccc(O)c(O)c1O]

2,3,4,4′-tetrahydroxy-benzophenone:

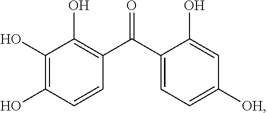 [SMILES: O=C(c1ccc(O)cc1O)c1ccc(O)c(O)c1O]

and combinations thereof.

In examples where the at least one hydrophilic functional group is the alkoxy group, the functionalized benzophenone is 4,4′-dimethoxybenophenone:

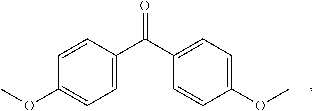

In other examples, the functionalized benzophenone may contain hydrophilic functional groups that are different. In these examples, the functionalized benzophenone is a benzophenone derivative including at least two different hydrophilic functional groups.

In one example, a first hydrophilic functional group of the at least two different hydrophilic functional groups is an alkoxy group, and a second hydrophilic functional group of the at least two different hydrophilic functional groups is a hydroxyl group. Some examples of these functionalized benzophenones include 2-hydroxy-4-dodecyloxy-benzophenone:

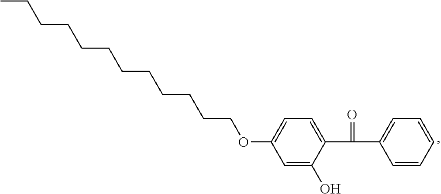 [SMILES: CCCCCCCCCCCCOc1ccc(C(=O)c2ccccc2)c(O)c1]

2-hydroxy-4-methoxy-benzophenone:

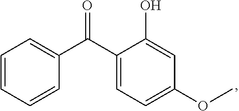 [SMILES: COc1ccc(C(=O)c2ccccc2)c(O)c1]

2,2′-hydroxy-4-methoxy-benzophenone:

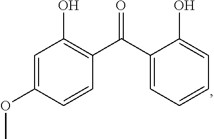 [SMILES: COc1ccc(C(=O)c2ccccc2O)c(O)c1]

and combinations thereof.

In another example, a first hydrophilic functional group of the at least two different hydrophilic functional groups may be selected from the group consisting of a hydroxy group and a carboxylic acid group, and a second hydrophilic functional group of the at least two different hydrophilic functional groups is an alkyl group. Some examples of these functionalized benzophenones include 2-hydroxy-4-methyl-benzophenone:

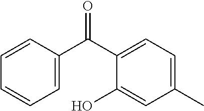 [SMILES: Cc1ccc(C(=O)c2ccccc2)c(O)c1]

and 4′-Methylbenzo-phenone-2-carboxylic acid:

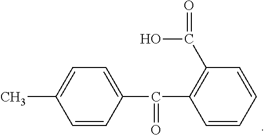 [SMILES: Cc1ccc(C(=O)c2ccccc2C(=O)O)cc1]

In yet another example, a first hydrophilic functional group of the at least two different hydrophilic functional groups is a hydroxy group, a second hydrophilic functional group of the at least two different hydrophilic functional groups is an alkoxy group, and a third hydrophilic functional group of the at least two different hydrophilic functional groups is a sulfonic acid group. An example of this functionalized benzophenone is 2-hydroxy-4-methoxy-benzophenone-5-sulfonic acid.

Examples of the functionalized benzophenones include 4-hydroxy-benzophenone, 2,4-dihydroxy-benzophenone, 4,4 dihydroxy-benzophenone, 2,4,4′-trihydroxy-benzophenone, 2,4,6 trihydroxy-benzophenone, 2,2′, 4,4′-tetrahydroxy-benzophenone, 4,4′-dimethoxybenzophenone, 4-aminobenzophenone, 4-dimethylamino-benzophenone, 2-hydroxy-4-methyl-benzophenone, 4′-methylbenzo-phenone-2-carboxylic acid, 2-hydroxy-4-dodecyloxy-benzophenone, 2-hydroxy-4-methoxy-benzophenone, 2-hydroxy-4-methoxy-benzophenone-5-sulfonic acid, 2,3,4-trihydroxy-benzophenone, 2,3,4,4′-tetrahydroxy-benzophenone, 2,2′-hydroxy-4-methoxy-benzophenone, and combinations thereof.

While several examples of functionalized benzophenones have been provided herein, it is to be understood that any benzophenone substituted with at least one hydrophilic functional group may be used. These may be naturally occurring or synthesized. As examples, benzophenone derivatives with at least one poly(ethylene glycol) (PEG) chain or with at least one phosphocholine chain may be synthesized.

The functionalized benzophenone is at least partially soluble in an aqueous vehicle of the fusing agent. The phrase “at least partially soluble” means that at least 0.5 wt % of the functionalized benzophenone is able to dissolve in the aqueous vehicle.

The amount of the functionalized benzophenone present in the UV light fusing agent will depend, in part, upon its solubility in the aqueous vehicle and its effect on the jettability of the fusing agent. The functionalized benzophenone may be present in an amount of from about 0.01 wt % active to about 10 wt % active of the total weight of the fusing agent. When the solubility limit of the functionalized benzophenone in the aqueous vehicle is low (e.g., is less than 5 wt % soluble), the functionalized benzophenone may be present in an amount of from about 0.01 wt % active to about 5 wt % active of the total weight of the fusing agent. In an example, the functionalized benzophenone may be present in an amount of from about 2 wt % active to about 4 wt % active of the total weight of the fusing agent.

Still another example of UV energy absorber is a plasmonic metal nanoparticle that i) provides absorption enhancement at radiation wavelengths of from about 340 nm to about 450 nm, and ii) is present in an amount up to 2 wt % active based on a total weight of the UV light fusing agent.

In an example, the plasmonic metal nanoparticle is selected from the group consisting of silver nanoparticles, gold nanoparticles, copper nanoparticles, aluminum nanoparticles, and combinations thereof. The example plasmonic metal nanoparticles do not merely absorb the UV in the selected range, they exhibit enhanced absorption caused by localized surface plasmon resonance in the near UV and the high photon energy end of visible range (range 340-450 nm). The phrase “absorbs radiation at wavelengths of from about 340 nm to about 450 nm” means that the plasmonic metal nanoparticle exhibits maximum absorption at a wavelength within the given range and/or has an absorbance greater than 1 (about 10% transmittance or less) at one or more wavelengths within the given range.

The plasmonic metal nanoparticle may have an average particle size of from about 1 nm to about 200 nm. In one example, the plasmonic metal nanoparticle has an average particle size of from about 1 nm to about 100 nm. In another example, the plasmonic metal nanoparticle has an average particle size of from about 1 nm to about 50 nm.

Yet another example of a suitable UV energy absorber is a fluorescent yellow dye having a targeted wavelength of maximum absorption for a 3D print system including the narrow UV-band emission source. The UV light absorber consists of the fluorescent yellow dye, without any other colorant. In particular, it would not be desirable to include any pigment or dye that absorbs other light, or any pigment that could crash out of solution when included with the fluorescent yellow dye.

The fluorescent yellow dye may be pyranine:

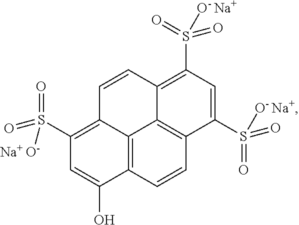

a pyranine derivative, coumarin:

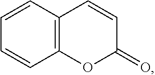 [SMILES: O=c1ccc2ccccc2o1]

a coumarin derivative, a naphthalimide:

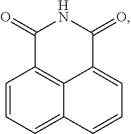 [SMILES: O=C1NC(=O)c2cccc3cccc1c23]

a naphthalimide derivative, a disazomethine derivative: RCH═N—N═CHR, or mixture of these compounds. Some specific examples include Solvent Green 7 (pyranine), Acid Yellow 184 (a coumarin derivative), Acid Yellow 250 (a coumarin derivative), Yellow 101, Basic Yellow 40 (a coumarin derivative), Solvent Yellow 43 (a naphthalimide derivative), Solvent Yellow 44 (a naphthalimide derivative), Solvent Yellow 85 (a naphthalimide derivative), Solvent Yellow 145 (a coumarin derivative), Solvent Yellow 160:1 (a coumarin derivative), and combinations thereof.

The fluorescent yellow dye may be present in the UV light fusing agent in an amount of from about 1 wt % active to about 10 wt % active, based on a total weight of the UV light fusing agent. In another example, the fluorescent yellow dye may be present in the fusing agent in an amount of from about 5 wt % active to about 8 wt % active, or from about 5.5 wt % active to about 7.5 wt % active.

### Fusinq Agent Vehicle

Any example of fusing agent #1, #2, or #3 (core fusing agent, primer fusing agent, UV light fusing agent) includes a liquid vehicle. The fusing agent vehicle, or “FA vehicle,” may refer to the liquid in which the energy absorber is/are dispersed or dissolved to form the respective fusing agent. A wide variety of FA vehicles, including aqueous and non-aqueous vehicles, may be used in the fusing agents. In some examples, the FA vehicle may include water alone or a non-aqueous solvent alone, i.e., with no other components. In other examples, the FA vehicle may include other components, depending, in part, upon the applicator that is to be used to dispense the fusing agent. Examples of other suitable fusing agent components include co-solvent(s), humectant(s), surfactant(s), antimicrobial agent(s), anti-kogation agent(s), chelating agent(s), buffer(s), pH adjuster(s), preservative(s), and/or combinations thereof.

Classes of water soluble or water miscible organic co-solvents that may be used in the fusing agents include aliphatic alcohols, aromatic alcohols, diols, glycol ethers, polyglycol ethers, lactams, formamides (substituted and unsubstituted), acetamides (substituted and unsubstituted), glycols, and long chain alcohols. Examples of these co-solvents include primary aliphatic alcohols, secondary aliphatic alcohols, 1,2-alcohols (e.g., 1,2-ethanediol, 1,2-propanediol, etc.), 1,3-alcohols (e.g., 1,3-propanediol), 1,5-alcohols (e.g., 1,5-pentanediol), 1,6-hexanediol or other diols (e.g., 2-methyl-1,3-propanediol, etc.), ethylene glycol alkyl ethers, propylene glycol, propylene glycol alkyl ethers, higher homologs (C₆-C₁₂) of polyethylene glycol alkyl ethers, diethylene glycol, triethylene glycol, tripropylene glycol methyl ether, tetraethylene glycol, glycerol, N-alkyl caprolactams, unsubstituted caprolactams, 2-pyrrolidone, 1-methyl-2-pyrrolidone, 1-(2-hydroxyethyl)-2-pyrrolidone (also known as N-(2-hydroxyethyl)-2-pyrrolidinone (HEP)), and the like. Other examples of organic co-solvents include dimethyl sulfoxide (DMSO), isopropyl alcohol, ethanol, pentanol, acetone, or the like.

The co-solvent(s) may be present in the fusing agent in a total amount of from about 1 wt % active to about 20 wt % active, based upon the total weight of the fusing agent. In an example, the fusing agent includes from about 2 wt % active to about 15 wt % active, or from about 5 wt % active to about 10 wt % active of the co-solvent(s).

The FA vehicle may also include humectant(s). An example of a suitable humectant is ethoxylated glycerin having the following formula:

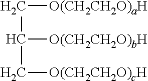

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

In an example, the total amount of the humectant(s) present in the fusing agent is from about 3 wt % active to about 10 wt % active, based on the total weight of the fusing agent.

The FA vehicle may also include surfactant(s). Suitable surfactant(s) include non-ionic or anionic surfactants. Some example surfactants include alcohol ethoxylates, alcohol ethoxysulfates, acetylenic diols, alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, fluorosurfactants, and the like. Some specific examples of non-ionic surfactants include the following from Evonik Degussa: SURFYNOL® SEF (a self-emulsifiable, wetting agent based on acetylenic diol chemistry), SURFYNOL® 440 or SURFYNOL® CT-111 (non-ionic ethoxylated low-foam wetting agents), SURFYNOL® 420 (non-ionic ethoxylated wetting agent and molecular defoamer), SURFYNOL® 104E (non-ionic wetting agents and molecular defoamer), and TEGO® Wet 510 (organic surfactant). Other specific examples of non-ionic surfactants include the following from The Dow Chemical Company: TERGITOL™ TMN-6, TERGITOL™ 15-S-7, TERGITOL™ 15-S-9, TERGITOL™ 15-S-12 (secondary alcohol ethoxylates). Other suitable non-ionic surfactants are available from Chemours, including the CAPSTONE® fluorosurfactants, such as CAPSTONE® FS-35 (a non-ionic fluorosurfactant). Some specific examples of anionic surfactants include alkyldiphenyloxide disulfonate (e.g., the DOWFAX™ series, such a 2A1, 3B2, 8390, C6L, C10L, and 30599, from The Dow Chemical Company), docusate sodium (i.e., dioctyl sodium sulfosuccinate), sodium dodecyl sulfate (SDS).

Whether a single surfactant is used or a combination of surfactants is used, the total amount of surfactant(s) in the fusing agent may range from about 0.01 wt % active to about 3 wt % active, based on the total weight of the fusing agent. In an example, the total amount of surfactant(s) in the fusing agent may be about 1 wt % active, based on the total weight of the build material reactive functional agent.

The FA vehicle may also include antimicrobial agent(s). Antimicrobial agents are also known as biocides and/or fungicides. Examples of suitable antimicrobial agents include the NUOSEPT® (Ashland Inc.), UCARCIDE™ or KORDEK™ or ROCIMA™ (The Dow Chemical Company), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (The Dow Chemical Company), and combinations thereof.

In an example, the total amount of antimicrobial agent(s) in the fusing agent is from about 0.01 wt % active to about 0.05 wt % active, based on the total weight of the fusing agent. In another example, the total amount of antimicrobial agent(s) in the fusing agent is about 0.04 wt % active, based on the total weight of the fusing agent.

The FA vehicle may also include anti-kogation agent(s) that is/are to be jetted using thermal inkjet printing. Kogation refers to the deposit of dried printing liquid (e.g., fusing agent) on a heating element of a thermal inkjet printhead. Anti-kogation agent(s) is/are included to assist in preventing the buildup of kogation.

Examples of suitable anti-kogation agents include oleth-3-phosphate (commercially available as CRODAFOS™ 03A or CRODAFOS™ N-3A) or dextran 500k. Other suitable examples of the anti-kogation agents include CRODAFOS™ HCE (phosphate-ester from Croda Int.), CRODAFOS® 010A (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used.

The anti-kogation agent may be present in the fusing agent in an amount of from about 0.1 wt % active to about 1.5 wt % active, based on the total weight of the fusing agent. In an example, the anti-kogation agent is present in an amount of about 0.5 wt % active, based on the total weight of the fusing agent.

Chelating agents (or sequestering agents) may be included in the FA vehicle of the fusing agent to eliminate the deleterious effects of heavy metal impurities. In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

Whether a single chelating agent is used or a combination of chelating agents is used, the total amount of chelating agent(s) in the fusing agent may range from greater than 0 wt % active to about 0.5 wt % active, based on the total weight of the fusing agent. In an example, the chelating agent is present in an amount of from about 0.05 wt % active to about 0.2 wt % active, based on the total weight of fusing agent. In another example, the chelating agent(s) is/are present in the fusing agent in an amount of about 0.05 wt % active, based on the total weight of the fusing agent.

Some examples of the fusing agent include a buffer. The buffer may be TRIS (tris(hydroxymethyl)aminomethane or TRIZMA®), TRIS or TRIZMA® hydrochloride, bis-tris propane, TES (2-[(2-Hydroxy-1,1-bis(hydroxymethyl)ethyl)amino]ethanesulfonic acid), MES (2-ethanesulfonic acid), MOPS (3-(N-morpholino)propanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid), Tricine (N-[tris(hydroxymethyl)methyl]glycine), HEPPSO (β-Hydroxy-4-(2-hydroxyethyl)-1-piperazinepropanesulfonic acid monohydrate), POPSO (Piperazine-1,4-bis(2-hydroxypropanesulfonic acid) dihydrate), EPPS (4-(2-Hydroxyethyl)-1-piperazinepropanesulfonic acid, 4-(2-Hydroxyethyl)piperazine-1-propanesulfonic acid), TEA (triethanolamine buffer solution), Gly-Gly (Diglycine), bicine (N,N-Bis(2-hydroxyethyl)glycine), HEPBS (N-(2-Hydroxyethyl)piperazine-N′-(4-butanesulfonic acid)), TAPS ([tris(hydroxymethyl)methylamino]propanesulfonic acid), AMPD (2-amino-2-methyl-1,3-propanediol), TABS (N-tris(Hydroxymethyl)methyl-4-aminobutanesulfonic acid), or the like.

In an example, the total amount of buffer(s) in the fusing agent is from about 0.01 wt % to about 3 wt %, based on the total weight of the fusing agent.

Some examples of the fusing agent include a pH adjuster. Suitable pH adjusters may include amino acids or sodium bicarbonate. An example of a suitable amino acid pH adjuster is taurine. In an example, the total amount of the pH adjuster(s) in the fusing agent is from about 0.01 wt % to about 3 wt %, based on the total weight of the fusing agent.

Some examples of the fusing agent include a preservative. Preservatives may be particular suitable when vitamin B or a vitamin B derivative is used as the energy absorber. Examples of suitable preservatives include 2-phenoxyethanol, sodium benzoate, and parabens. In an example, the total amount of the preservative(s) in the fusing agent is from about 0.1 wt % to about 3 wt %, based on the total weight of the UV light fusing agent.

Some examples of the fusing agent, particularly the UV light fusing agent, also include a base. In some examples, the B vitamin or the B vitamin derivative is more soluble at a neutral or basic pH. For example, folic acid is more soluble in an aqueous vehicle having a pH greater than 5. As such, it may be desirable to add a base, such as potassium hydroxide, sodium hydroxide, or tetramethylammonium hydroxide, until the desired pH is obtained. In an example, the total amount of the base in the fusing agent is from about 0.5 wt % to about 5 wt %, based on the total weight of the fusing agent. In other examples, the amount of base may range from about 0.75 wt % to about 2.5 wt %, based on the total weight of the fusing agent.

The balance of the fusing agent is water (e.g., deionized water, purified water, etc.). The amount of water may vary depending upon the amounts of the other components in the fusing agent. In one example, the fusing agent is jettable via a thermal inkjet printhead, and includes from about 50 wt % to about 90 wt % water.

### Fusing Agent #4

Still another example of a fusing agent (“Fusing Agent #4”) is referred to as a color fusing agent, because it includes a colored visible light absorber (which exhibits absorption at least at wavelengths in the visible region). The visible wavelength of light may range from 400 nm to 780 nm. In an example, the visible wavelength of light may be approximately 455 nm.

The color fusing agent includes a first solvent to provide a polymer plasticizer, a second, water miscible solvent, and the colored visible light absorber that absorbs a visible wavelength of light.

The first solvent may be a plasticizer and/or may have plasticizing characteristics when interacting with the build material composition of Implementation 1 or the build material of Implementation 2. For example, the first solvent may interact with the thermoplastic polyurethane to lower the melting temperature of the build material composition. The first solvent may be an organic solvent, such as benzyl alcohol or diethylene glycol butyl ether (DEGBE).

The first solvent may be present in the color fusing agent in an amount ranging from about 10 wt % active to about 40 wt % active.

The second solvent may be a water miscible solvent that is compatible with the colored visible light absorber. The second solvent may help keep the colored visible light absorber dissolved in the water of the color fusing agent and help provide stability and prevent aggregation of the colored visible light absorber over time. In an example, the second solvent may include at least one of diethylene glycol (DEG) butyl ether, 1,2-hexanediol, hydroxyethyl-2-pyrrolidone (HE2P), glycerol, propylene glycol and its oligomers, ethylene glycol and its oligomers, or 1,5-pentanediol.

The second solvent may be present in the color fusing agent in an amount ranging from about 30 wt % active to about 60 wt % active.

In an example, the colored visible light absorber may be any colored light absorber that can absorb light with a visible wavelength. For example, the colored visible light absorber may absorb light having a wavelength of between 400 nm to 780 nm. In one specific example, the colored visible light absorber may be a dye that absorbs light at approximately 455 nm. Examples of a colored visible light absorber that can absorb light having a wavelength of approximately 455 nm include acid yellow 23 (AY-23), acid yellow 1, pyranine, and direct black 168 (DB-168).

The colored visible light absorber may be present in the color fusing agent in an amount less than 3 wt % active. As an example, the colored visible light absorber may be added in amounts as low as less than 0.05 wt % active of a total weight of the color fusing agent. As another example, the colored visible light absorber may be added at 0.75 wt % active. In still another example, the colored visible light absorber may be added to an amount ranging from about 0.1 wt % active to 3 wt % active, based on the total weight of the color fusing agent.

By using a relatively low amount of the colored visible light absorber, different colored fusing agents may be formulated by using small amounts of colored dyes that do not impact the fusing performance of the color fusing agent. As such, some examples of the color fusing agent also include an additional colored dye that does not absorb the same wavelength of light as the colored visible light absorber. The additional colored dye can be used to formulate different colored fusing agents without affecting the overall fusing behavior of the different colored fusing agents. Examples of the colored dye may include C854, AY 17, Acid Red (AR) 52, AR 289, Reactive Red 180 (RR 180), Direct Blue (DB) 199, Pigment Blue (PB) 15:3, Pigment Red (PR) 122, Pigment Yellow (PY) 155, PY 74, and cesium tungsten oxide.

The amount of the additional dye ranges from about 0.10 wt % active to about 3 wt % active, based on the total weight of the color fusing agent. The amount of the additional dye may be varied to achieve a desired color. For example, more of the additional dye may be added when it is desirable to form dark colored parts (e.g., dark magenta, dark cyan, etc.) and less of the additional dye may be added when it is desirable to form light colored parts (e.g., light magenta, light cyan, etc.).

The color fusing agent may also include any of the other suitable fusing agent components, such as humectant(s), surfactant(s), antimicrobial agent(s), anti-kogation agent(s), buffer(s), pH adjuster(s), and/or combinations thereof. Any of these components may be added in the amounts set forth herein for the fusing agent vehicle (except that the total amount is with respect to the color fusing agent). In one example, the color fusing agent further includes a surfactant in an amount ranging from about 0.5 wt % active to about 1 wt % active. The surfactant may include a secondary alcohol ethoxylate, such as TERGITOL™15-S-9, or other water-soluble non-ionic surfactants set forth herein.

### Detailing Agent

The 3D printing method involving the selective application of the fusing agent to pattern the layer of the build material composition may also involve the selective application of a detailing agent. The detailing agent does not include an energy absorber, and may be applied to portion(s) of the build material composition that is/are outside of an area based on the 3D digital model used for forming the 3D printed article. The portion(s) of the build material composition exposed to the detailing agent may experience a cooling effect, and thus the detailing agent helps to keep the portion(s) from coalescing. The detailing agent may also be applied in the same portion(s) as the fusing agent. In these examples, the cooling effect of the detailing agent may be used to modulate the extent of fusing in the portion(s).

The detailing agent may include a surfactant, a co-solvent, and a balance of water. In some examples, the detailing agent consists of these components, and no other components. In some other examples, the detailing agent may further include a colorant. In still some other examples, the detailing agent consists of a colorant, a surfactant, a co-solvent, and a balance of water, with no other components. In yet some other examples, the detailing agent may further include additional components, such as anti-kogation agent(s), antimicrobial agent(s), and/or chelating agent(s) (each of which is described above in reference to the fusing agent).

The surfactant(s) that may be used in the detailing agent include any of the surfactants listed herein in reference to the fusing agent. The total amount of surfactant(s) in the detailing agent may range from about 0.10 wt % active to about 5.00 wt % active with respect to the total weight of the detailing agent.

The co-solvent(s) that may be used in the detailing agent include any of the co-solvents listed above in reference to the fusing agent. The total amount of co-solvent(s) in the detailing agent may range from about 1 wt % active to about 65 wt % active with respect to the total weight of the detailing agent.

In some examples, the detailing agent does not include a colorant. In these examples, the detailing agent may be colorless. As used herein, the term “colorless,” means that the detailing agent is achromatic and does not include a colorant. The colorless detailing agent may be used with any of the fusing agents disclosed herein.

In other examples, the detailing agent does include a colorant. It may be desirable to add color to the detailing agent when the detailing agent is applied to the edge of a colored 3D printed article, such as an article formed using the core fusing agent. Color in the detailing agent may be desirable when used at an edge of the article because some of the colorant may become embedded in the build material composition that fuses/coalesces at the edge. As such, in some examples, the dye in the detailing agent may be selected so that its color matches the color of the energy absorber in the fusing agent. As examples, the dye may be any azo dye having sodium or potassium counter ion(s) or any diazo (i.e., double azo) dye having sodium or potassium counter ion(s), where the color of azo or dye azo dye matches the color of the fusing agent.

When the detailing agent includes the colorant and is to be used with the core fusing agent, the colorant may be a dye of any color having substantially no absorbance in a range of 650 nm to 2500 nm. By “substantially no absorbance” it is meant that the dye absorbs no radiation having wavelengths in a range of 650 nm to 2500 nm, or that the dye absorbs less than 10% of radiation having wavelengths in a range of 650 nm to 2500 nm. The dye may also be capable of absorbing radiation with wavelengths of 650 nm or less. As such, the dye absorbs at least some wavelengths within the visible spectrum, but absorbs little or no wavelengths within the near-infrared spectrum. This is in contrast to the energy absorber in the core fusing agent, which absorbs wavelengths within the near-infrared spectrum. As such, the colorant in the detailing agent will not substantially absorb the fusing radiation, and thus will not initiate melting and fusing (coalescence) of the build material composition in contact therewith when the build material layer is exposed to the energy.

In an example, the dye is a black dye. Some examples of the black dye include azo dyes having sodium or potassium counter ion(s) and diazo (i.e., double azo) dyes having sodium or potassium counter ion(s). Examples of azo and diazo dyes may include tetrasodium (6Z)-4-acetamido-5-oxo-6-[[7-sulfonato-4-(4-sulfonatophenyl)azo-1-naphthyl]hydrazono]naphthalene-1,7-disulfonate with a chemical structure of:

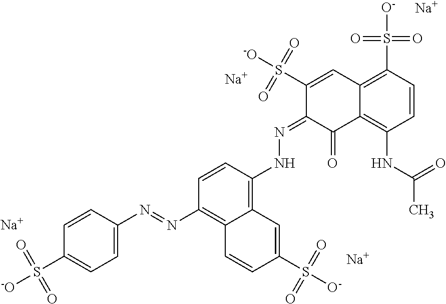

(commercially available as Food Black 1); tetrasodium 6-amino-4-hydroxy-3-[[7-sulfonato-4-[(4-sulfonatophenyl)azo]-1-naphthyl]azo]naphthalene-2,7-disulfonate with a chemical structure of:

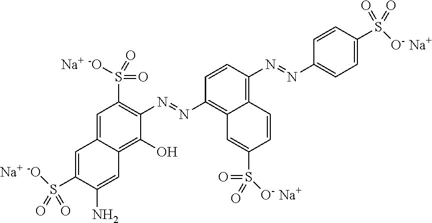

(commercially available as Food Black 2) tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

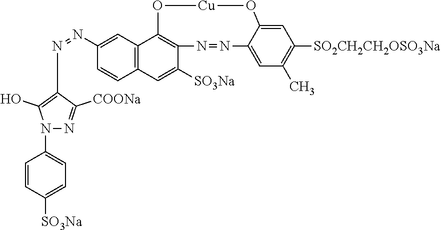

(commercially available as Reactive Black 31); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

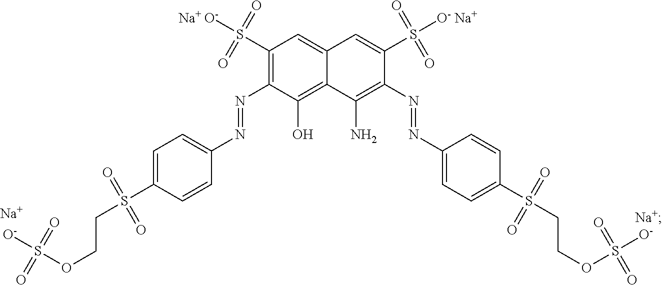

and combinations thereof. Some other commercially available examples of the dye used in the detailing agent include multipurpose black azo-dye based liquids, such as PRO-JET® Fast Black 1 (made available by Fujifilm Holdings), and black azo-dye based liquids with enhanced water fastness, such as PRO-JET® Fast Black 2 (made available by Fujifilm Holdings).

In some instances, in addition to the black dye, the colorant in the detailing agent may further include another dye. In an example, the other dye may be a cyan dye that is used in combination with any of the dyes disclosed herein. The other dye may also have substantially no absorbance above 650 nm. The other dye may be any colored dye that contributes to improving the hue and color uniformity of the final 3D printed object.

Some examples of the other dye include a salt, such as a sodium salt, an ammonium salt, or a potassium salt. Some specific examples include ethyl-[4-[[4-[ethyl-[(3-sulfophenyl) methyl] amino] phenyl]-(2-sulfophenyl) ethylidene]-1-cyclohexa-2,5-dienylidene]-[(3-sulfophenyl) methyl] azanium with a chemical structure of:

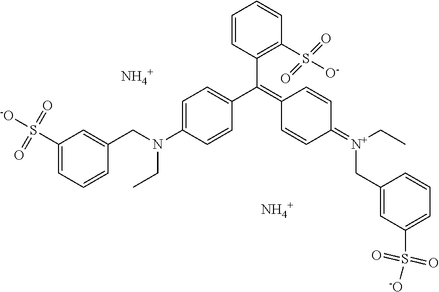

(commercially available as Acid Blue 9, where the counter ion may alternatively be sodium counter ions or potassium counter ions); sodium 4-[(E)-{4-[benzyl(ethyl)amino]phenyl}{(4E)-4-[benzyl(ethyl)iminio]cyclohexa-2,5-dien-1-ylidene}methyl]benzene-1,3-disulfonate with a chemical structure of:

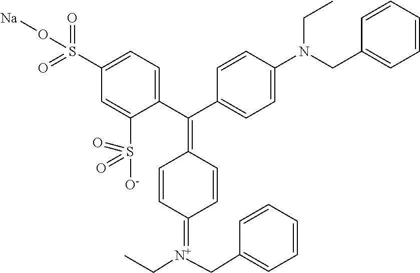

(commercially available as Acid Blue 7); and a phthalocyanine with a chemical structure of:

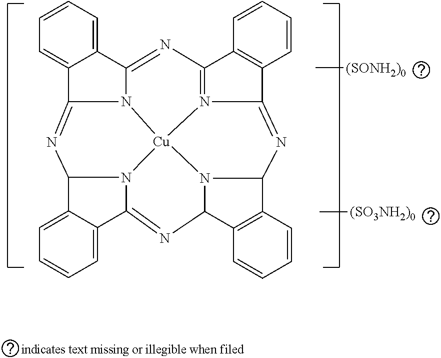

(commercially available as Direct Blue 199), and combinations thereof.

In an example of the detailing agent, the dye may be present in an amount of from about 1 wt % active to about 3 wt % active, based on the total weight of the detailing agent. In another example of the detailing agent including a combination of dyes, one dye (e.g., the black dye) is present in an amount of from about 1.50 wt % active to about 1.75 wt % active, based on the total weight of the detailing agent, and the other dye (e.g., the cyan dye) is present in an amount of from about 0.25 wt % active to about 0.50 wt % active, based on the total weight of the detailing agent.

The balance of the detailing agent is water. As such, the amount of water may vary depending upon the amounts of the other components that are included.

### Coloring Agent

The 3D printing method involving the selective application of the fusing agent to pattern the layer of the build material composition may also involve the selective application of a coloring agent. The coloring agent may be used to impart color to the 3D printed article.

In these examples, the coloring agent is separate from the fusing agent. A coloring agent separate from the fusing agent may be desirable because the two agents can be applied separately, thus allowing control over where color is added. The coloring agent may be applied during printing (e.g., on the build material composition with the fusing agent) or after printing (e.g., on a 3D printed article) to impart a colored appearance to the 3D printed article.

The coloring agent may include a colorant, a co-solvent, and a balance of water. In some examples, the coloring agent is made up of these components, and no other components. In still other examples, the coloring agent may further include additional components that aid in colorant dispersability and/or ink jettability. Some examples of additional coloring agent components include dispersant(s) (e.g., a water-soluble acrylic acid polymer (e.g., CARBOSPERSE® K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), or water-soluble styrene-maleic anhydride copolymers/resins), humectant(s), surfactant(s), anti-kogation agent(s), and/or antimicrobial agent(s) (examples of which are described herein in reference to the fusing agent).

The coloring agent may be a black agent, a cyan agent, a magenta agent, or a yellow agent. As such, the colorant may be a black colorant, a cyan colorant, a magenta colorant, a yellow colorant, or a combination of colorants that together achieve a black, cyan, magenta, or yellow color. While some examples have been provided, it is to be understood that other colored inks may also be used.

The colorant of the coloring agent may be any pigment or dye. When the coloring agent is a separate agent, the pigment or dye is to impart color, and is not meant to replace the energy absorber in the fusing agent. As such, the colorant may function as an energy absorber or as a partial energy absorber, or may not provide any energy absorption.

An example of the pigment based colored ink may include from about 1 wt % to about 10 wt % of pigment(s), from about 10 wt % to about 30 wt % of co-solvent(s), from about 1 wt % to about 10 wt % of dispersant(s), 0.01 wt % to about 1 wt % of anti-kogation agent(s), from about 0.05 wt % to about 0.1 wt % antimicrobial agent(s), and a balance of water. An example of the dye based colored ink may include from about 1 wt % to about 7 wt % of dye(s), from about 10 wt % to about 30 wt % of co-solvent(s), from about 1 wt % to about 7 wt % of dispersant(s), from about 0.05 wt % to about 0.1 wt % antimicrobial agent(s), from 0.05 wt % to about 0.1 wt % of chelating agent(s), from about 0.005 wt % to about 0.2 wt % of buffer(s), and a balance of water.

### 3D Printing Kit

The build material composition may be part of a 3D printing kit along with one or more of the fusing agents described above. In one example, the 3D printing kit is a single fusing agent kit including the build material composition and a single fusing agent (such as, e.g., a core fusing agent or a primer fusing agent or a UV light fusing agent or a color fusing agent). In another example, the 3D printing kit is a multi-fusing agent kit including the build material composition and two or more fusing agents (such as, e.g., the core fusing agent and the primer fusing agent).

Any example of the 3D printing kit may also be a multi-fluid kit, which includes the build material composition (which is a dry or solid component), one or more of the fusing agents, as well as the detailing agent and/or the coloring agent described above.

It should be understood that the fluid(s) and the build material composition of the 3D printing kit may be maintained separately until used together in the 3D printing method described below. The fluid(s) and/or the build material composition may each be contained in one or more containers prior to and during printing, but may be combined together during printing. The containers can be any type of a vessel (e.g., a reservoir), box, or receptacle made of any material.

### 3D Printing Method

A 3D printing method utilizing the build material composition is described below with reference to FIG. 1. The 3D printing method utilizes a 3D printing system 100. The printing system 100 includes a build area platform 102 having a build surface 104 upon which the 3D printed article is built, formed, or created. The build surface 104 defines an X-Y plane for building the 3D printed article. The build area platform 102 is movable in a direction along the Z-axis, as denoted by the arrow A in FIG. 1. In addition, the build area platform 102 is programmable, based on the 3D digital model, to move along the Z-axis, such as in a downward direction as shown in the example depicted in FIG. 1, to enable delivery of the build material composition 10 to the build surface 104 or to a previously formed layer on the build surface 104. It is noted that the build area platform 102 is also movable along the Z-axis in an opposite direction to return the build area platform 102 to its initial position once the 3D printed article has been built.

The 3D printing system 100 further includes a build material supply 106 for holding the build material composition 10. The build material supply 106 may be a container, bed, or other surface and is configured to position the build material composition 10 between the build material distributor 108 and the build area platform 102 during printing. In an example, the build material supply 106 includes heaters so that the build material composition 10 can be heated to a suitable supply temperature, such as from about 25° C. to about 135° C. The supply temperature may depend, in part, on the build material composition 10 and/or the 3D printing system 100. As such, the range provided is one example, and higher or lower temperatures may be used as long as the supply temperature is below the lowest temperature of the melting range of the thermoplastic polyurethane particles in the build material composition 10.

The 3D printing system 100 further includes a build material distributor 108 coupled to the build material supply 106. The distributor 108 is movable in both directions along the Y-axis, as denoted by arrow B in FIG. 1, over the build material supply 106 and across the build area platform 102 for spreading the build material composition 10 to form a build material layer 16. The distributor 108 may be a blade (e.g., a doctor blade), a roller, a combination of a roller and a blade, and/or any other device capable of spreading the build material composition 10 over the build area platform 102. In one example, the distributor 108 is a counter-rotating roller.

The 3D printing system 100 further includes a heating source adapted to expose the build material composition 10 deposited on the build area platform 102 to heat. Examples of the heat source include a thermal heat source (e.g., a heater (not shown) integrated into the build area platform 102 (which may include sidewalls)) or a radiation source 110.

The 3D printing system 100 further includes an applicator 112 coupled to a fluid supply (not shown) and adapted to dispense a fluid (such as the fusing agent 18) onto selected portion(s) of the build material composition 10. The fusing agent 18 is dispensed onto the selected portion(s) of the build material composition 10 according to the 3D digital model. In an example, the applicator 112 includes a thermal inkjet printhead, a piezoelectric printhead, a continuous inkjet printhead, etc. and the selective application of the fusing agent 18 may be accomplished by thermal inkjet printing, piezoelectric inkjet printing, continuous inkjet printing, etc. Other devices capable of jetting a fluid using inkjet technology are also contemplated for the applicator 112.

In an example, the 3D printing system 100 could include at least one additional applicator 112′, and another fluid 22, such as the detailing agent or the coloring agent, may be dispensed from the at least one additional applicator 112′. The at least one additional applicator 112′ includes any of the inkjet printheads and corresponding inkjet technologies mentioned above. In addition, the applicators 112, 112′ may be separate applicators or may be a single applicator with several individual cartridges for dispensing the respective fluids 18, 22. Additional applicators may also be used in instances when more than two fluids are required.

The printing system 100 further includes a controller (not shown). The controller is configured to access data stored in a data store pertaining to the 3D article to be built. In an example, the data include the 3D digital model of the 3D article to be built, as well as additional data such as the number of build material layers 16 to be formed, locations at which a fluid is to be deposited on which one or more of the build material layers 16, etc.

Prior to performing the 3D printing method for Implementation 1, the build material composition 10 may first be prepared by combining the thermoplastic polyurethane particles 12 and the thermally conductive filler 14 together to form a dry blend. As mentioned above, both the thermoplastic polyurethane particles 12 and the thermally conductive filler 14 may be provided as powders. In an example, combining may involve dry mixing the powders together to form the dry blend. The combining step may be accomplished by mixing the powder together in a mixer or blender suitable for combining dry components. The amount of mixing time may be any amount of time suitable to form a homogenous mixture of the thermoplastic polyurethane 12 and the filler 14.

Details of the 3D printing method for Implementation 1 will now be described. The 3D printing method includes the step of applying the build material composition 10 to form a build material layer 16, where the build material composition 10 includes the thermoplastic polyurethane particles 12 present in an amount of from about 90 wt % to about 99 wt % and the thermally conductive filler 14 present in an amount of from about 1 wt % to about 10 wt %. The thermally conductive filler 14 is selected from the group consisting of cubic boron nitride and diamond-like carbon. The amounts of the thermoplastic polyurethane particles 12 and the thermally conductive filler 14 are based on a total weight of the build material composition 10.

The step of applying the build material composition 10 includes pushing, via the build material distributor 108, a predetermined amount of the build material composition 10 out of the supply 106 and onto the surface 104 of the build area platform 102. In an example, the build area platform 102 is programmed (via the controller) to advance along the direction of arrow A enough so that the build material distributor 108 can push the build material composition 10 onto the build area platform 102. The build area platform 102 may further be programmed to return to its original position, for example, when the 3D printed article has been built and thus the 3D printing method is complete.

The method further includes the step of spreading the build material composition 10. Spreading is performed by the distributor 108 moving in the Y-direction of the X-Y plane to form a substantially uniform layer 16 of the build material composition 10. Afterwards, the distributor 108 is returned to a position adjacent the supply 106. In some instances, the supply 106 or a portion of the supply 106 translates along with the distributor 108 so that the build material composition 10 is delivered continuously to the build area platform 102 rather than being supplied from a single location at the side of the printing system 100 as shown in FIG. 1.

In an example, the supply 106 supplies the build material composition 10 into a position so that the build material composition 10 is ready to be spread onto the build area platform 102. The build material distributor 108 spreads the supplied build material composition 10 onto the build area platform 102. The controller processes “control build material supply” data, and in response, controls the supply 106 to appropriately position the particles 12, 14 of the build material composition 10. The controller also processes “control spreader data,” and in response, controls the distributor 108 to spread the build material composition 10 over the build area platform 102 to form the build material layer 16. One build material layer 16 has been formed in FIG. 1.

The build material layer 16 that is formed has a substantially uniform thickness across the build area platform 102. In an example, the build material layer 16 has a thickness of from about 50 μm to about 120 μm. In another example, the thickness of the build material layer 16 is from about 30 μm to about 200 μm. It is to be understood that thinner or thicker layers may also be used. The layer thickness may be about 2× (i.e., 2 times) the average particle size (e.g., diameter) of the—thermoplastic polyurethane particles at a minimum for finer part definition. In some examples, the layer thickness may be about 1.2× the average diameter of the thermoplastic polyurethane particles in the build material composition 10.

After the build material composition 10 has been applied and spread, and prior to further processing, the method includes the step of pre-heating the build material layer 16. The pre-heating step is performed to heat the build material layer 16, and is performed prior to the step of applying a fluid, such as the fusing agent 18, which is described below. In an example, the pre-heating temperature may be below the lowest melting temperature of the melting range of the thermoplastic polyurethane particles 12 in the build material composition 10. As an example, the heating temperature may range from about 10° C. to about 100° C. below the lowest melting temperature of the thermoplastic polyurethane particles 12. In a particular example, the pre-heating temperature ranges from about 45° C. to about 135° C.

After the build material layer 16 has been formed and in some instances pre-heated, the method further includes, based on the 3D digital model, the step of selectively applying the fusing agent 18, including an energy absorber, on at least a portion of the build material layer 16 to generate a patterned portion 20. The fusing agent 18 is dispensed from the applicator 112 as mentioned above. In an example, the controller processes data for a corresponding layer of the 3D object model, and in response, controls the applicator 112 to selectively deposit the fusing agent 18 onto the predetermined portion(s) 20 of the build material layer 16. The predetermined portion of the build material layer 18 patterned with the fusing agent 18 are referred to herein as the patterned portion(s) 20.

Any one of the core fusing agent, the primer fusing agent, the UV light fusing agent, or the color fusing agent may be used as the fusing agent 18. When it is desirable to form a white, colored, or slightly tinted layer of the 3D article, the primer fusing agent or the UV light fusing agent may be used to pattern the layer 16 of the build material composition 10. The primer fusing agent or the UV light fusing agent is clear or slightly tinted (depending upon the energy absorber used), and thus the resulting layer of the 3D printed article may appear white, lightly colored (e.g., yellow), or the color of the build material composition 10. When it is desirable to form a layer of a particular color (e.g., magenta, cyan, blue, etc.), the color fusing agent may be used. When it is desirable to form a darker color or black layer, the core fusing agent may be used. The core fusing agent is dark or black, and thus the resulting layer of the 3D printed article may appear grey, black or another dark color. Use of two or more of the fusing agents could also be used to pattern different portions of a single build material layer. In addition, color may be added by using the coloring agent (as described below).

The amount of the fusing agent 18 that is applied to the build material composition 10 in the patterned portion 20 should be sufficient to absorb and convert enough electromagnetic radiation so that the build material composition 10 in the patterned portion 20 will coalesce/fuse. The amount of the fusing agent 18 that is applied depends, at least in part, on the energy absorber used, the energy absorber loading in the fusing agent 18, and the components of the build material composition 10 (in particular, the amount of the thermally conductive filler 14 in the build material composition 10). In particular, the concentration of the energy absorber in the fusing agent 18 can be considered. This concentration can be used to determine how much fusing agent 18 to apply to achieve a weight ratio of fusing agent 18 to build material composition 10 for acceptable layer-by-layer fusing. Thus, if applying the fusing agent 18 (10 wt %) to the build material composition 10 (90 wt %) at about a 1:9 weight ratio, then the energy absorber to build material composition 10 weight ratio (as applied) can be from about 1:9000 to about 1:22.5. If more (up to 20 wt %) or less (down to 5 wt %) of the fusing agent 18 is applied to the build material composition 10, then these ratios can be adjusted accordingly. That stated, the weight ratio of the energy absorber to the build material composition 10 (as applied) in some more specific examples can be from about 1:1000 to about 1:80, from about 1:800 to about 1:100, or from about 1:500 to about 1:150, for example.

The selective application of the fusing agent 18 may be accomplished in a single printing pass or in multiple printing passes. In some examples, the fusing agent 18 is selectively applied during a single printing pass. In some other examples, the fusing agent 18 is selectively applied during multiple printing passes, such as from 2 to 4 passes. It may be desirable to apply the fusing agent 18 in multiple printing passes to increase the amount, e.g., of the energy absorber that is applied to the build material composition 10, to avoid liquid splashing, to avoid displacement of the build material composition 10, etc.

In an example, another fluid 22, such as the detailing agent or the coloring agent, may be dispensed from the additional applicator 112′. The other fluid 22 may be selectively applied in a single printing pass or in multiple printing passes.

In the example shown in FIG. 1, the other fluid 22 is the detailing agent, which is selectively applied to portion(s) 36 of the layer 16 that are outside of the patterned portion(s) 20. These portion(s) 36 are not patterned with the fusing agent 18, and thus are not to become part of the final 3D printed article layer 24. Thermal energy generated during radiation exposure may propagate into the surrounding portion(s) 36 that do not have the fusing agent 18 applied thereto. The propagation of thermal energy may be inhibited, and thus the coalescence of the non-patterned build material portion(s) 36 may be prevented, when the detailing agent is applied to these portion(s) 36. While not shown in FIG. 1, the detailing agent may also or alternatively be applied to the patterned portion(s) 20 with the fusing agent 18 in order to reduce the extent of fusing in the patterned portion(s) 20. In these examples, the amount of the detailing agent (other fluid 22) that is applied should be low enough so that fusing is not completely inhibited.

After the agent 18 and/or fluid 22 has/have been selectively applied in the specific portion(s) 20, 36 of the build material layer 16, the entire layer 16 of the build material composition 10 is exposed to electromagnetic radiation (shown as EMR in FIG. 1).

The electromagnetic radiation is emitted from the radiation source 110. The length of time the electromagnetic radiation is applied for, or energy exposure time, may be dependent, for example, on one or more of: characteristics of the radiation source 110; characteristics of the build material composition 10; and/or characteristics of the fusing agent 18. For example, the presence of the filler 14 in the build material composition 10 increases the thermal conductivity of the build material composition 10, thus enabling the build material composition 10 to heat up and melt faster than when the filler 14 is not present. Thus, the presence of the filler 14 may reduce the amount of time required for electromagnetic radiation exposure. In an example, the electromagnetic radiation exposure is performed for a time of from about 0.5 seconds to about 4 seconds. In addition, by virtue of the presence of the filler 14, the electromagnetic radiation exposure can be performed at a reduced energy level, e.g., when compared to the energy level used with a thermoplastic polyurethane build material composition does not contain the filler 14.

The electromagnetic radiation exposure may be accomplished in a single radiation event or in multiple radiation events. The term “radiation event,” as used herein, refers to one period of exposure of electromagnetic radiation from the radiation source 110. In an example, a radiation event may occur as a pass of a moveable radiation source 110 over the build material layer 16 (similar to a printing pass). In an example, the number of radiation events ranges from 1 to 8, and thus may be performed as a single radiation event or as multiple events. It may be desirable to expose the build material composition 10 to electromagnetic radiation in multiple radiation events to counteract a cooling effect that may be brought on by the amount of the fusing agent 18 (alone or in combination with the other fluid 22) that is applied to the build material layer 16. Additionally, it may be desirable to expose the build material composition 10 to electromagnetic radiation in multiple radiation events to sufficiently elevate the temperature of the build material composition 10 in the patterned portion(s) 20, without overheating the build material composition 10 in the non-patterned portion(s) 36.

The fusing agent 18 enhances the absorption of the radiation, converts the absorbed radiation to thermal energy, and promotes the transfer of the thermal heat to the build material composition 10 in contact therewith. The enhanced thermal conductivity of the build material composition 10 enables the patterned portion(s) 20 to reach the melting range of the thermoplastic polyurethane particles 12 more efficiently than in the absence of the filler 14. As such, the combination of the filler 14 and the fusing agent 18 sufficiently elevates the temperature of the build material composition 10 in the patterned portion 20 to a temperature above the lowest melting temperature of the thermoplastic polyurethane particles, allowing coalescing/fusing (e.g., thermal merging, melting, binding, etc.) of the build material composition 10 to take place. The application of the electromagnetic radiation forms a layer 24 of the 3D printed article.

In some examples, the electromagnetic radiation has a wavelength of from 100 nm to 400 nm, from 400 nm to 4000 nm, or from 800 nm to 1400 nm, or from 800 nm to 1200 nm. The radiation used depends upon the fusing agent 18 that is used. Radiation having wavelengths within the appropriate ranges may be absorbed by the fusing agent 18 and may heat the build material composition 10 in contact therewith, and may not be absorbed by the non-patterned build material composition 10 (e.g., in portion(s) 36).

After the layer 24 of the 3D printed article has been formed, additional layer(s) may be formed thereon to create an example of the 3D printed article. To form the next layer, additional build material composition 10 is applied on the layer 24 of the 3D printed article. The fusing agent 18 is then selectively applied on at least a portion of the additional build material composition 10 according to data derived from the 3D digital model. After the fusing agent 18 is applied (alone or in combination with the other fluid 22), the entire layer of the additional build material composition 10 is exposed to the electromagnetic radiation in the manner described above. The application of additional build material composition 10, the selective application of the fusing agent 18, and the electromagnetic radiation exposure may be repeated a predetermined number of cycles to form the final 3D printed article in accordance with the 3D digital model. Details of the 3D printed article are described below.

The 3D printed articles generated using the method of Implementation 1 may appear dark when the core fusing agent is used, or white or the color of the build material composition 10 when the primer or UV fusing agent is used, or may have a slight color when the UV fusing agent is used, or may be colored when the color fusing agent is used. For the lighter colored 3D printed articles, color may be added during 3D printing or after the 3D printed article is generated by using the separate coloring agent.

In one example, the method further comprises selectively applying, based on the 3D object model, a coloring agent to the patterned portion(s) 20. In this example, the coloring agent is applied to the build material composition 10 along with the fusing agent 18. In this example, the colorant of the coloring agent becomes embedded throughout the coalesced/fused build material composition 10 of the 3D article layers 24. To introduce the color, it may be desirable to introduce the coloring agent to patterned portions 20 that define an edge boundary of the 3D printed article being formed.

In yet another example, the method further comprises selectively applying, based on the 3D object model, a coloring agent to the 3D printed article layer 24 (after coalescence takes place). In this example, the coloring agent is applied to the exterior surface of the 3D printed article layer 24.

In the examples disclosed herein, a 3D printed article may be printed in any orientation. For example, the 3D printed article can be printed from bottom to top, top to bottom, on its side, at an angle, or any other orientation. The orientation of the 3D object can also be formed in any orientation relative to the layering of the build material composition 10. For example, the 3D printed article can be formed in an inverted orientation or on its side relative to the layering of the build material composition 10. The orientation of the build within each layer 16 can be selected in advance or even by the user at the time of printing, for example.

### Implementation 2

In Implementation 2, the thermally conductive filler is incorporated into a thermally conductive agent that is selective applied to layers of a build material, rather than being incorporated into the build material composition 10 as described in Implementation 1. During 3D printing, the build material is patterned with both the thermally conductive agent and the fusing agent, and is exposed to electromagnetic radiation to initiate coalescence of the polymer in the build material composition.

### Build Material

In implementation 2, the build material includes the thermoplastic polyurethane particles 12. The thermoplastic polyurethane particles for the build material for Implementation 2 are the same thermoplastic polyurethane particles used for the build material composition described above for Implementation 1.

In an example, the build material consists of the thermoplastic polyurethane particles 12. In other words, the build material is free from any additional component (including the filler 14 described in the build material composition 10 of Implementation 1) and, as such, 100% of the build material is the thermoplastic polyurethane particles 12. In another example, the build material may include one or more additives, such as the antioxidant, the whitener, the antistatic agent, the flow aid, or a combination thereof as described in reference to the build material composition 10 of Implementation 1.

### Thermally Conductive Agent

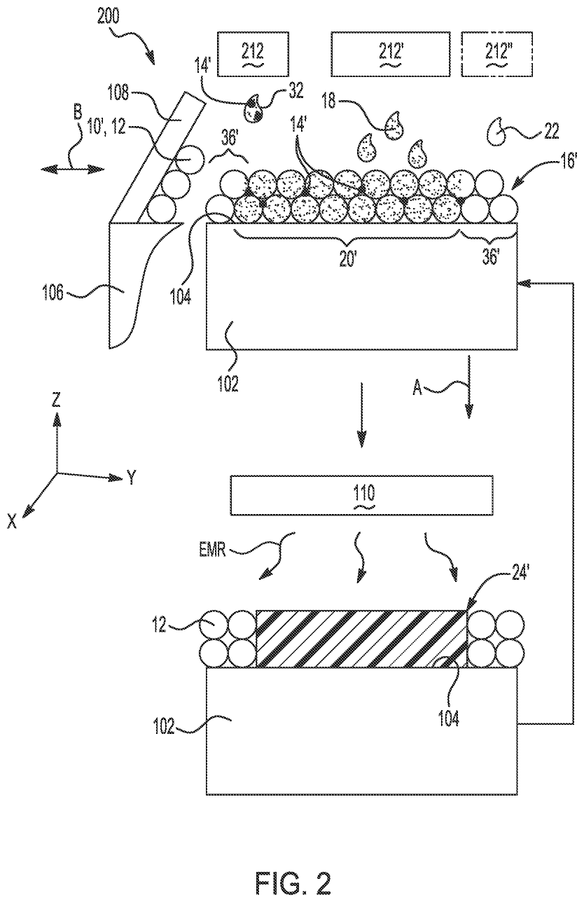

Examples of the thermally conductive agent include an aqueous vehicle and a thermally conductive filler (shown as 14′ in FIG. 2) dispersed in the aqueous vehicle. The thermally conductive agent is a fluid, and deposition of the thermally conductive agent, and therefore the thermally conductive filler 14′, is achieved using inkjet technology during 3D printing. Additionally, the thermally conductive filler 14′ in the thermally conductive agent does not adversely affect the mechanical properties of the 3D printed article.

The thermally conductive filler 14′ is selected from the group consisting of cubic boron nitride and diamond-like carbon. The chemical, physical, and mechanical properties of the cubic boron nitride and diamond-like carbon that can be used as the thermally conductive filler 14′ are the same as the cubic boron nitride and the diamond-like carbon described herein for the thermally conductive filler 14, with the caveat that the size of the filler 14′ is specifically selected so that it is jettable from an inkjet printer.

As such, in instances where the thermally conductive filler 14′ is cubic boron nitride nanoparticles, the cubic boron nitride nanoparticles have, for example, a particle size of from about 8 nm to about 300 nm. In another example, the cubic boron nitride nanoparticles have a particle size of from about 8 nm to about 150 nm. Similarly, in instances where the thermally conductive filler 14′ is diamond-like carbon nanoparticles, the diamond-like carbon nanoparticles have, for example, a particle size of from about 3 nm to about 300 nm. In another example, the diamond-like carbon nanoparticles have a particle size of from about 8 nm to about 150 nm.

In an example, the thermally conductive filler 14′ may be self-dispersed. The self-dispersed thermally conductive filler 14′ include cubic boron nitride or diamond-like carbon nanoparticles with an organic group attached to the surface. The organic group is selected from the group consisting of carboxylate, a fatty acid chain, sulfonyl, and poly(ethylene glycol). Surface modification of the thermally conductive filler 14′ may be dependent on the ability to modify the surface of the filler 14′ with NaOH or HNO₃ to produce hydroxyl groups (—OH) that can be reacted with silane coupling agents containing the listed organic dispersing groups.

In some examples, the solid powder form of the cubic boron nitride or the diamond-like carbon is added to the liquid vehicle to form the thermally conductive agent.

In other examples, the thermally conductive filler 14′ is present in a dispersion before being incorporated into the thermally conductive agent. As an example, cubic boron nitride nanopowder may be mixed with water to form a CBN dispersion that is then mixed with the liquid vehicle to form the thermally conductive agent. As another example, diamond-like carbon may be commercially available in the form of an aqueous dispersion. In these examples, thermally conductive filler 14′ is present in the dispersion in an amount ranging from about 0.5 wt % to about 50 wt %, based on a total weight of the dispersion. In another example, the thermally conductive filler 14′ is present in the dispersion in an amount ranging from about 10 wt % to about 50 wt %, based on a total weight of the dispersion. It is to be understood that any liquid components of the dispersion become part of the thermally conductive agent.

The solid form of the thermally conductive filler 14′ or the dispersion containing the thermally conductive filler 14′ may be incorporated with the liquid vehicle components to form the thermally conductive agent. The solid form or the dispersion may be added so that the amount of the thermally conductive filler 14′ that is present in the thermally conductive agent is up to about 15 wt % active based on a total weight of the thermally conductive agent. In another example, the thermally conductive filler 14′ is present in an amount of from about 1 wt % active to about 10 wt % active, based on the total weight of the thermally conductive agent. In another example, the thermally conductive filler 14′ is present in an amount of from about 4 wt % active to about 6 wt % active, based on the total weight of the thermally conductive agent. In a particular example, the thermally conductive filler 14′ is present in an amount of about 5 wt % active, based on the total weight of the thermally conductive agent.

The aqueous vehicle for the thermally conductive agent includes water, a co-solvent, and an additive selected form the group consisting of a surfactant and/or a dispersant, an anti-kogation agent, an antimicrobial agent, a pH buffer, and combinations thereof. Any of the examples of the co-solvent, the surfactant, the anti-kogation agent, the antimicrobial agent, the pH buffer used for the fusing agent vehicle (FA vehicle) described above in connection with Implementation 1 can also be used for the liquid vehicle of the thermally conductive agent in Implementation 2. However, the loading of the individual components of the liquid vehicle for the thermally conductive agent may differ from that of the FA vehicle. The loading of each of the individual components of the liquid vehicle of the thermally conductive agent is set forth below.

The co-solvent(s) may be present in the liquid vehicle in an amount of from about 1 wt % active to about 50 wt % active, based upon the total weight of the thermally conductive agent. In an example, the liquid vehicle includes from about 5 wt % active to about 30 wt % active of the co-solvent(s).

The total amount of surfactant(s) (whether a single surfactant or a combination of surfactants is/are used) in the liquid vehicle is from about 0.01 wt % active to about 3 wt % active, based on the total weight of the thermally conductive agent. In an example, the total amount of surfactant(s) in the liquid vehicle is about 0.85 wt % active, based on the total weight of the thermally conductive agent.

A dispersant separate from the surfactant may be desirable to disperse the filler 14′ throughout the vehicle of the thermally conductive agent. Some specific examples of suitable dispersants include water-soluble styrene-acrylic acid copolymers/resins (e.g., JONCRYL® 60 series, JONCRYL® 400 series, or JONCRYL® 600 series, available from BASF Corp.) or water-soluble styrene-maleic anhydride or styrene maleimide dispersants from Cray Valley/Polyscope or BYK Additives and Instruments. When included, the dispersant may be present in the thermally conductive agent in a weight ratio of filler 14′ to dispersant of from 5:1 or 10:1.

The anti-kogation agent is present in the liquid vehicle in an amount of from about 0.1 wt % active to about 1.5 wt % active, based on the total weight of the thermally conductive agent. In an example, the anti-kogation agent is present in an amount of about 0.5 wt % active, based on the total weight of the thermally conductive agent.

The total amount of antimicrobial agent(s) in the liquid vehicle is from about 0.01 wt % active to about 0.5 wt % active, based on the total weight of the thermally conductive agent. In an example, the amount of antimicrobial agent(s) is about 0.32 wt % active, based on the total weight of the thermally conductive agent.

The total amount of buffer(s) in the liquid vehicle is from about 0.01 wt % active to about 3 wt % active, based on a total weight of the thermally conductive agent. In an example, the buffer(s) is present in an amount of about 0.1 wt % active, based on the total weight of the thermally conductive agent.

The balance of the liquid vehicle of the thermally conductive agent is water (e.g., deionized or another form of purified water).

### Fusing Agent

Any of the fusing agents 18 described herein in reference to Implementation 1 may be used with the thermally conductive agent in Implementation 2.

### 3D Printing Kit

The thermally conductive agent may be part of a multi-fluid kit along with one or more of the fusing agent(s) described herein (e.g., with the UV light fusing agent, with both the core and primer fusing agents, etc.). Some examples of a multi-fluid kit also include the detailing agent and/or the coloring agent described in reference to Implementation 1.

The thermally conductive agent may be part of a 3D printing kit along with the build material. One or more of the fusing agents described above for Implementation 1 is/are also included in the 3D printing kit. In one example, the 3D printing kit is a single fusing agent kit including the build material, the thermally conductive agent, and a single fusing agent (such as, e.g., a core fusing agent or a primer fusing agent or a UV light fusing agent or a color fusing agent). In another example, the 3D printing kit is a multi-fusing agent kit including the build material, the thermally conductive agent, and two or more fusing agents (such as, e.g., the core fusing agent and the primer fusing agent). The 3D printing kit may also include other fluids as well, such as the detailing agent and/or the coloring agent. Details of the detailing agent and/or the coloring agent are described above for Implementation 1.

It should be understood that the fluids of a milt-fluid kit or the fluid(s) and the build material of the 3D printing kit may be maintained separately until used together in the examples of the 3D printing methods described below. The fluid(s) and/or the build material may each be contained in one or more containers prior to and during printing, but may be combined together during printing. The containers can be any type of a vessel (e.g., a reservoir), box, or receptacle made of any material.

### 3D Printing Method

A 3D printing method utilizing the thermally conductive agent is described below with reference to FIG. 2. The 3D printing method utilizes a 3D printing system 200. The printing system 200 is similar to the printing system 100, and includes the build area platform 102 having the build surface 104 upon which the 3D printed article is built. The 3D printing system 200 further includes the build material supply 106 for holding the build material described in Implementation 2, the build material distributor 108 coupled to the build material supply 106, and a heating source, such as the radiation source 110. The components 102, 104, 106, 108, and 110 are the same physical components that operate in the same way as previously described for the 3D printing system 100 of Implementation 1.

The 3D printing system 200 further includes at least two applicators 212, 212′ each coupled to a fluid supply (not shown) and each adapted to independently dispense a respective fluid. One of the applicators 212 is adapted to dispense the thermally conductive agent 32 (which includes the thermally conductive filler 14′) onto selected portion(s) of the build material 10′ (which is the thermoplastic polyurethane particles 12 with or without the build material additives set forth herein) according to a 3D digital model (described below). The other one of the applicators 212′ is adapted to dispense the fusing agent 18 onto the selected portion(s) of the build material composition 10 also according to the 3D digital model. In an example, each of the applicators 212, 212′ includes a thermal inkjet printhead, a piezoelectric printhead, a continuous inkjet printhead, etc. and the selective and respective application of the thermally conductive agent 32 and the fusing agent 18 may be accomplished by thermal inkjet printing, piezoelectric inkjet printing, continuous inkjet printing, etc. Other devices capable of jetting a fluid using inkjet technology are also contemplated for the applicators 212, 212′.

In an example, the 3D printing system 200 also includes at least one additional applicator 212″, and another fluid 22, such as the detailing agent or the coloring agent, may be dispensed from the at least one additional applicator 212″. The at least one additional applicator 212″ includes any of the inkjet printheads and corresponding inkjet technologies mentioned above. In addition, the applicators 212, 212′, 212″ may be separate applicators or may be a single applicator with several individual cartridges for dispensing the respective fluids. Additional applicators may also be used in instances when more than two fluids are used.

The printing system 200 further includes a controller (not shown). The controller is configured to access data stored in a data store pertaining to the 3D article to be built. In an example, the data include the 3D digital model of the 3D article to be built, as well as additional data, such as the number of build material layers 16′ to be formed, locations at which a fluid is to be deposited on one or more of the build material layers 16′, etc.

Details of the 3D printing method for Implementation 2 will now be described. The 3D printing method includes the step of applying the build material 10′ to form the build material layer 16, where the build material 10′ includes the thermoplastic polyurethane particles 12 without the filler 14, and with or without one or more of the build material additives set forth herein. The step of applying the build material 10′ includes pushing, via the build material distributor 108, a predetermined amount of the build material 10′ out of the supply 106 and onto the surface 104 of the build area platform 102. In an example, the build area platform 102 is programmed (via the controller) to advance along the direction of arrow A (shown in FIG. 2) enough so that the build material distributor 108 can push the build material 10′ onto the build area platform 102. The build area platform 102 may further be programmed to return to its original position, for example, when the 3D printed article has been built and thus the 3D printing method is complete.

The method further includes the step of spreading the build material 10′. Spreading is performed by the distributor 108 moving in the Y-direction of an X-Y plane of the platform 102 to form a substantially uniform layer 16′ of the build material 10′. Afterwards, the distributor 108 is returned to a position adjacent the supply 106. In some instances, the supply 106 or a portion of the supply 106 translates along with the distributor 108 so that the build material 10′ is delivered continuously to the build area platform 102 rather than being supplied from a single location at the side of the printing system 200 as shown in FIG. 2.

In an example, the supply 106 supplies the build material 10′ into a position so that the build material 10′ is ready to be spread onto the build area platform 102. The build material distributor 108 spreads the supplied build material 10′ onto the build area platform 102. The controller processes “control build material supply” data, and in response, controls the supply 106 to appropriately position the thermoplastic polyurethane particles 12. The controller also processes “control spreader data,” and in response, controls the distributor 108 to spread the build material 10′ over the build area platform 102 to form the build material layer 16′. One build material layer 16′ has been formed in FIG. 2.

The build material layer 16′ formed has a substantially uniform thickness across the build area platform 102. In an example, the build material layer 16′ has a thickness of from about 50 μm to about 120 μm. In another example, the thickness of the build material layer 16′ is from about 30 μm to about 300 μm. It is to be understood that thinner or thicker layers may also be used. For example, the thickness of the build material layer 16′ may be from about 20 μm to about 500 μm. The layer thickness may be about 2× (i.e., 2 times) the average particle size (e.g., diameter) of the thermoplastic polyurethane particles 12 at a minimum for finer part definition. In some examples, the layer thickness may be about 1.2× the average diameter of the thermoplastic polyurethane particles 12 in the build material 10′.

After the build material 10′ has been applied and spread, and prior to further processing, the method includes the step of pre-heating the build material layer 16′. Pre-heating may be performed as described in reference to Implementation 1.

After the build material layer 16′ has been formed and in some instances pre-heated, the method further includes, based on the 3D digital model, selectively and respectively applying the fusing agent 18 and the thermally conductive agent 32 on the same portion(s) of the build material layer 16′ to form at least one patterned portion(s) 20′. In this example method, the fusing agent 18 is applied to define the portion(s) 20′ of the layer 16′ that will become part of the 3D printed particle layer 24 and the thermally conductive agent 32 is applied to the same portion(s) 20′ in order to increase the thermal conductivity of the build material 10′ in the portion(s) 20′.

The thermally conductive agent 32 is dispensed from the applicator 212 as mentioned above. In an example, the controller processes data, and in response, controls the applicator 212 to deposit the thermally conductive agent 32 onto the predetermined portion(s) 20′ of the build material layer 16′. The amount of the thermally conductive agent 32 that is applied to the build material layer 16′ depends upon the loading of the filler 14′ in the agent 32 and the desired loading of the filler 14′ throughout the layer 16′. In an example, enough of the thermally conductive agent 32 is added to the build material layer 16′ so that from about 1 wt % to about 10 wt % of the filler 14′ is added to the portion 20′ (where the weight is based on the combined weight of the build material in the portion 20′ and the filler 14′ in the portion 20′).

The thermally conductive filler 14′ is dispersed throughout the liquid vehicle of the thermally conductive agent 32. When the agent 32 is applied to the portion(s) 20′, the filler 14′ may be introduced to the portion(s) homogeneously. This enables the portion(s) 20′ to exhibit substantially uniform enhanced thermal properties (e.g., conductivity).

The fusing agent 18 is dispensed from the applicator 212′, as mentioned above. In an example, the controller processes data, and in response, controls the applicator 212′ to deposit the fusing agent 18 onto the predetermined portion(s) 20′ of the build material layer 16′.

Any one of the core fusing agent, the primer fusing agent, the UV light fusing agent, or the color fusing agent may be used as the fusing agent 18. When it is desirable to form a white, colored, or slightly tinted layer 24′ of the 3D printed article, the primer fusing agent or the UV light fusing agent or the color fusing agent may be used to pattern the layer 16′ build material 10′. The primer fusing agent or the UV light fusing agent is clear or slightly tinted (depending upon the energy absorber used), and thus the resulting layer of the 3D printed article may appear white, lightly colored (e.g., yellow), or the color of the build material 10′. The color fusing agent may impart a particular color (e.g., cyan, blue, magenta, etc.) to the 3D printed article. When it is desirable to form a darker color or black layer, the core fusing agent may be used. The core fusing agent is dark or black, and thus the resulting layer of the 3D printed article may appear grey, black or another dark color. Use of two or more of the fusing agents 18 could also be used to pattern different portions of a single build material layer.

The amount of the fusing agent 18 that is applied to the build material layer 16′ to form the patterned portion(s) 20′ should be sufficient to absorb and convert enough electromagnetic radiation so that the build material 10′ in the patterned portion(s) 20′ will coalesce/fuse. The amount of the fusing agent 18 that is applied depends, at least in part, on the energy absorber used, the energy absorber loading in the fusing agent 18, and the amount of the thermally conductive agent 32 (and in particular, the filler 14′) that is applied with the fusing agent 18. In particular, the concentration of the energy absorber in the fusing agent 18 can be considered. This concentration can be used to determine how much fusing agent 18 to apply to achieve a weight ratio of fusing agent 18 to build material 10′ for acceptable layer-by-layer fusing. Thus, if applying the fusing agent 18 (10 wt %) to the build material 10′ (90 wt %) at about a 1:9 weight ratio, then the energy absorber to build material 10′ weight ratio (as applied) can be from about 1:9000 to about 1:22.5. If more (up to 20 wt %) or less (down to 5 wt %) of the fusing agent 18 is applied to the build material 10′, then these ratios can be adjusted accordingly.

The selective and respective application of the thermally conductive agent 32 and the fusing agent 18 may be independently accomplished in a single printing pass or in multiple printing passes. In some examples, the thermally conductive agent 32 is selectively applied during a single printing pass, and the fusing agent 18 is then selectively applied during a single printing pass. In some other examples, the thermally conductive agent 32 is selectively applied during multiple printing passes, and then the fusing agent 18 is selectively applied during multiple printing passes. In still other examples, the fusing agent 18 is applied before the thermally conductive agent 32, or the two agents 18, 32 are applied during the same printing pass(es). The multiple printing passes for each the application of the thermally conductive agent 32 and the fusing agent 18 is, e.g., from 1 to 8 passes.

In the example shown in FIG. 2, the other fluid 22 is the detailing agent, which is selectively applied to portion(s) 36′ of the layer 16′ that are outside of the patterned portion(s) 20′. These portion(s) 36′ are not patterned with the fusing agent 18, and thus are not to become part of the final 3D printed article layer 24′. Thermal energy generated during radiation exposure may propagate into the surrounding portion(s) 36′ that do not have the fusing agent 18 applied thereto. The propagation of thermal energy may be inhibited, and thus the coalescence of the non-patterned build material portion(s) 36′ may be prevented, when the detailing agent is applied to these portion(s) 36′. While not shown in FIG. 2, the detailing agent may also or alternatively be applied to the patterned portion(s) 20′ with the fusing agent 18 and the thermally conductive agent 32 in order to reduce the extent of fusing in the patterned portion(s) 20′. In these examples, the amount of the detailing agent (other fluid 22) that is applied should be low enough so that fusing is not completely inhibited.

After the agents 32, 18 have been selectively applied on the predetermined portion(s) 20′ of the build material layer 16′, the entire layer 16′ is exposed to electromagnetic radiation (shown as EMR in FIG. 2). The electromagnetic radiation is emitted from the radiation source 110. In some examples, the electromagnetic radiation has a wavelength of from 100 nm to 400 nm, from 400 nm to 4000 nm, or from 800 nm to 1400 nm, or from 800 nm to 1200 nm. The radiation used depends upon the fusing agent 18 that is used. Radiation having wavelengths within the appropriate ranges may be absorbed by the fusing agent 18 and may heat the build material 10′ in contact therewith, and may not be absorbed by the non-patterned build material 10′ (e.g., in portion(s) 36′).

In this example method, electromagnetic radiation exposure may be performed in the same manner as described in reference to FIG. 1. In this example, the length of time the electromagnetic radiation is applied for, or energy exposure time, may be dependent, for example, on one or more of: characteristics of the radiation source 110; characteristics of the build material 10′; characteristics of the thermally conductive agent 32; and/or characteristics of the fusing agent 18. In addition, the presence of the filler 14′ in the portion(s) 20′ may reduce the amount of time required for electromagnetic radiation exposure. Any of the exposure times set forth in Implementation 1 may be used in Implementation 2.

The electromagnetic radiation exposure may be accomplished in a single radiation event or in multiple radiation events. In an example, the number of radiation events ranges from 1 to 8. It may be desirable to expose the build material composition 10 to electromagnetic radiation in multiple radiation events to counteract a cooling effect that may be brought on by the amount of the thermally conductive agent 32 and the amount of the fusing agent 18 that are applied to the build material layer 16′. Additionally, it may be desirable to expose the build material layer 16′ to electromagnetic radiation in multiple radiation events to sufficiently elevate the temperature of the build material 10′ in the patterned portion(s) 20, without overheating the build material 10′ in the non-patterned portion(s) 36′.

The fusing agent 18 enhances the absorption of the radiation, converts the absorbed radiation to thermal energy, and promotes the transfer of the thermal heat to the build material 10′ in contact therewith. The enhanced thermal conductivity of the build material 10′ as a result of the selectively applied filler 14′ enables the patterned portion(s) 20′ to reach the melting range of the thermoplastic polyurethane particles 12 more efficiently than in the absence of the filler 14′. As such, the combination of the filler 14′ and the fusing agent 18 sufficiently elevates the temperature of the build material 10′ in the patterned portion 20′ to a temperature above the lowest melting temperature of the thermoplastic polyurethane particles 12, allowing coalescing/fusing (e.g., thermal merging, melting, binding, etc.) of the build material 10′ to take place. The application of the electromagnetic radiation forms a layer 24′ of the 3D printed article.

After the layer 24′ of the 3D printed article has been formed, additional layer(s) may be formed thereon to create an example of the 3D printed article. To form a next layer, additional build material 10′ is applied on the layer 24′ of the 3D printed article. The thermally conductive agent 32 is then selectively applied on at least a portion of the additional build material 10′ according to data received from the 3D digital model. Then, the fusing agent 18 and the thermally conductive agent 32 are respectively selectively applied on the portion(s) 20′ of the additional build material 10′, according to data derived from the 3D digital model. After the thermally conductive agent 32 and the fusing agent 18 have been applied, the entire layer of the additional build material 10′ is exposed to the electromagnetic radiation in the manner described above. The application of additional build material 10′, the selective application of the thermally conductive agent 32, the selective application of the fusing agent 18, and the electromagnetic radiation exposure may be repeated a predetermined number of cycles to form the final 3D printed article in accordance with the 3D digital model. Details of the 3D printed article are described below.

The 3D printed articles generated using the method of Implementation 2 may appear dark when the core fusing agent is used, or white or the color of the build material composition 10 when the primer or UV fusing agent is used, or may have a slight color when the UV fusing agent is used, or may be a particular color when the color fusing agent is used. For the lighter colored 3D printed articles, color may be added during 3D printing or after the 3D printed article is generated by using the separate coloring agent.

In one example, the method further comprises selectively applying, based on the 3D object model, a coloring agent to the patterned portion(s) 20′. In this example, the coloring agent is applied to the build material 10′ along with the fusing agent 18 and the thermally conductive agent 32. In this example, the colorant of the coloring agent becomes embedded throughout the coalesced/fused build material 10′ of the 3D article layers 24′. To introduce the color, it may be desirable to introduce the coloring agent to patterned portions 20′ that define an edge boundary of the 3D printed article being formed.

In yet another example, the method further comprises selectively applying, based on the 3D object model, a coloring agent to the 3D printed article layer 24′ (after coalescence takes place). In this example, the coloring agent is applied to the exterior surface of the 3D printed article layer 24′.

In the examples disclosed herein, a 3D printed article may be printed in any orientation. For example, the 3D printed article can be printed from bottom to top, top to bottom, on its side, at an angle, or any other orientation. The orientation of the 3D object can also be formed in any orientation relative to the layering of the build material 10′. For example, the 3D printed article can be formed in an inverted orientation or on its side relative to the layering of the build material 10′. The orientation of the build within each layer 16′ can be selected in advance or even by the user at the time of printing, for example.

### 3D Printed Article

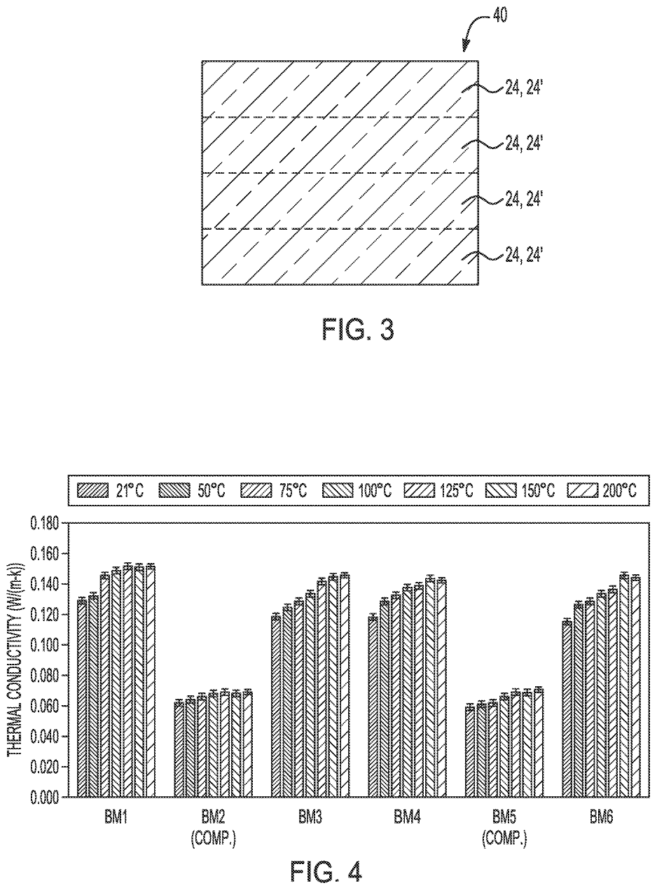

Each of the 3D printing methods of Implementations 1 and 2 form a 3D printed article. As shown in FIG. 3, the 3D printed article 40 includes a plurality of the layers 24 or 24′ of coalesced thermoplastic polyurethane particles, and the thermally conductive filler 14 or 14′ and the energy absorber intermingled throughout the coalesced thermoplastic polyurethane particles. The coalesced thermoplastic polyurethane particles are present in an amount of from about 90 wt % to about 99 wt %, based on a total weight of the 3D printed article 40. The thermally conductive filler 14 or 14′ is present in an amount of from about 1 wt % to about 10 wt %, based on the total weight of the 3D printed article, and is selected from the group consisting of cubic boron nitride and diamond-like carbon. In instances when the thermally conductive filler 14 or 14′ is cubic boron nitride, in a particular example, the cubic boron nitride is present in an amount of about 5 wt %, based on the total weight of the 3D printed article 40. In instances when the thermally conductive filler 14 or 14′ is diamond-like carbon, in a particular example, the diamond-like carbon is present in an amount of about 5 wt %, based on the total weight of the 3D printed article 40. Typically, other liquid vehicle components such as water, co-solvents, etc. are evaporated during processing, and as such, negligible amounts would remain in the final 3D printed article.

While four of the layers 24, 24′ are shown in FIG. 3, the 3D printed article 40 can have as many layers 24, 24′ as needed to form the 3D printed article 40. In addition, the individual layers 24, 24′ are depicted in FIG. 3 as being enlarged for purposes of illustration. It should be understood that the individual layers 24, 24′ have a thickness that is much smaller than shown, such as for example, from about 20 μm to about 200 μm as mentioned above. Furthermore, once the layers 24, 24′ are formed, the layers 24, 24′ coalesce at the respective interfaces to form a single unit.

To further illustrate the present disclosure, example(s) are given herein. It is to be understood that these example(s) are provided for illustrative purposes and are not to be construed as limiting the scope of the present disclosure.

### EXAMPLES

### Example 1

Six samples of build material compositions (BM1, BM2, BM3, BM4, BM5, BM6) were prepared. One type of thermoplastic polyurethane powder (from BASF Corp.), was used for three of the samples (BM1, BM2, BM3), and another type of thermoplastic polyurethane powder (from Lubrizol), was used for the other three samples (BM4, BM5, BM6). The build material compositions BM1 and BM4 were each prepared by mixing 95 wt % of a thermoplastic polyurethane powder with 5 wt % of cubic boron nitride (having 99.99% purity) to form a dry blend. The build material compositions BM3 and BM6 were each prepared by mixing 95 wt % of a thermoplastic polyurethane powder with 5 wt % of diamond-like carbon to form a dry blend. The build material compositions BM1, BM3, BM4, and BM6 were representative of the build material composition of the present disclosure (the cubic boron nitride or the diamond-like carbon was the thermally conductive filler).

The build material compositions BM2 and BM5 each consisted of the respective thermoplastic polyurethane powders (i.e., 100 wt % thermoplastic polyurethane powder without any added filler). As such, the build material compositions BM2, BM5 were comparative samples.

Several tests were performed utilizing each of the samples BM1, BM3, BM4, BM6 and each of the comparative samples BN2, BN5 to determine the effect of the fillers on the thermal properties of the build material composition. To briefly summarize the results, each of the samples BM1, BM3, BM4, BM6 (containing the filler) showed an improvement in its thermal properties (in terms of thermal conductivity, enthalpy, and thermal window) compared to the comparative samples BN2, BN5 (containing no filler).

### Thermal Conductivity

The thermal stability of all six samples (BM1, BM2, BM3, BM4, BM5, BM6) was tested using a transient plane source (TPS) method.

The thermal conductivity for each of the samples was determined at a temperature of 21° C., 50° C., 75° C., 100° C., 125° C., 150° C., and 200° C., and the results are set forth in the graph depicted in FIG. 4. The results show that the samples BM1, BM3, BM4, BM6, including one of the thermally conductive fillers, have significantly higher thermal conductivity values (from about 0.110 W/m-K to about 0.150 W/m-K) compared to the comparative samples BM2, BM5 (from about 0.060 W/m-K to about 0.070 W/m-K). These results show an improvement in thermal conductivity by the presence of either of the fillers in the build material composition.

### Melting Enthalpy

The melting enthalpy, also referred to as the heat of fusion, is the amount of heat energy in Joules/gram (J/g) required to change the state of matter of a substance (i.e., the thermoplastic polyurethane) from a solid to a liquid. The melting enthalpy of each of the six samples was determined using differential scanning calorimetry (DSC).

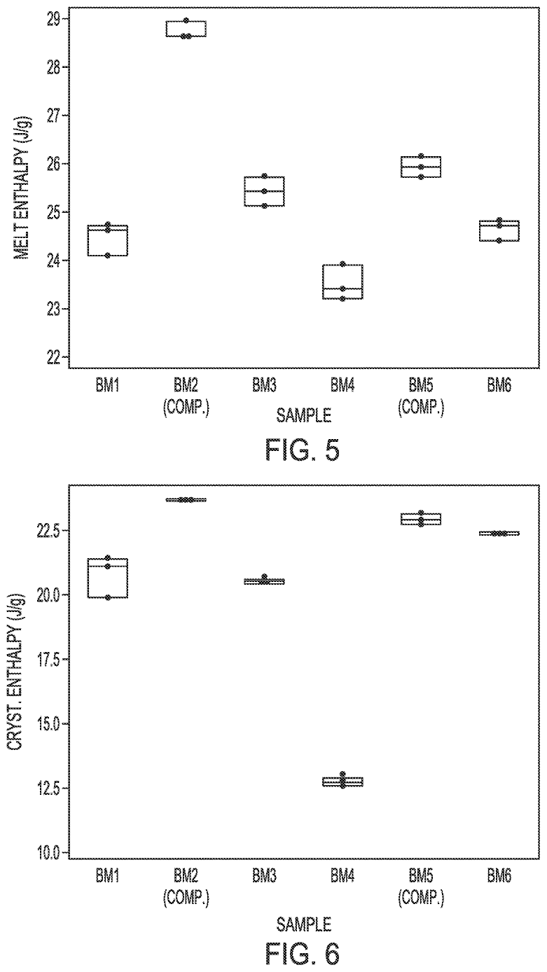

The melting enthalpies (J/g) of the six samples are depicted in the graph shown in FIG. 5. The results show that the melting enthalpy of the samples BM1, BM3, BM4, BM6, including one of the thermally conductive fillers, is significantly reduced compared to the comparative samples BM2, BM5. The decrease in melting enthalpy demonstrates that either of the fillers in the build material composition can lead to faster melting than the comparative samples that do not contain either of the fillers.

### Crystallization Enthalpy

The crystallization enthalpy, also referred to as heat of crystallization, is the heat energy (J/g) absorbed when one mole of a substance (e.g., the TPU) crystallizes from a saturated solution of the same substance. The crystallization enthalpy of each of the six samples was also determined using DSC.

The crystallization enthalpies (J/g) of the six samples are depicted in the graph shown in FIG. 6. Similar to the melting enthalpy, the results show that the crystallization enthalpy of the samples BM1, BM3, BM4, BM6 including the thermally conductive filler is significantly reduced compared to the comparative samples BM2, BM5.

### Thermal Window

The thermal window is the difference between the end of melt transition and the start of the crystallization transition. The thermal window for each of the six samples was determined by DSC.

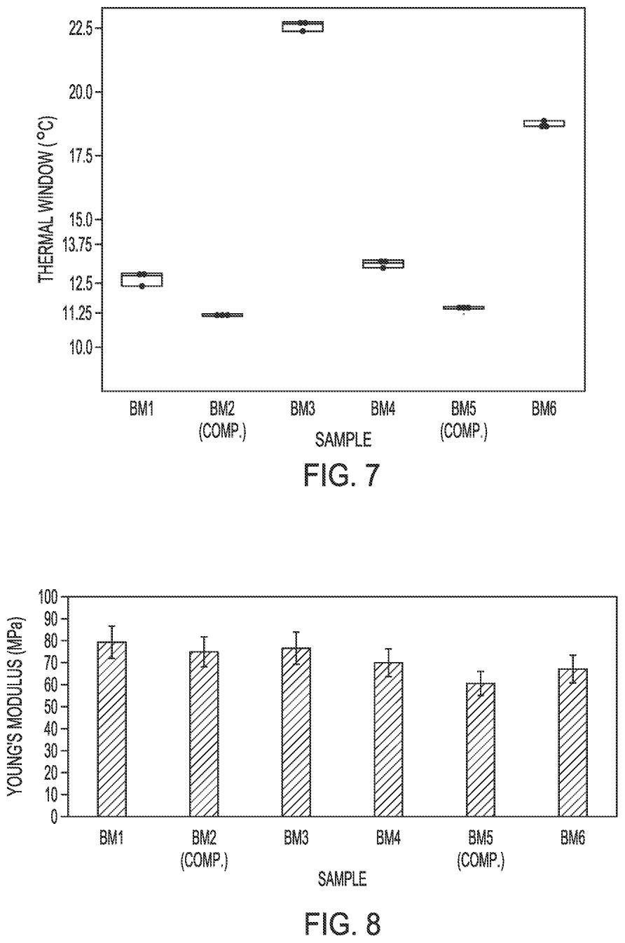

The thermal windows (° C.) of the six samples are depicted in the graph shown in FIG. 7. The results show that the thermally conductive filler in samples BM1, BM3, BM4, BM6 increased the thermal window of the build material compositions compared to the comparative samples BM2, BM5. For example, the thermal window for sample BM1 and BM4, each of which included cubic boron nitride, was about 12.7° C. and 13.75° C., respectively, compared to the comparative sample BM2 containing the same type of thermoplastic polyurethane but no filler, which was about 11.25° C. A more significant increase in the thermal window was shown with samples BM3 and BM6, each of which included the diamond-like carbon, when compared to comparative sample BM5 containing the same type of thermoplastic polyurethane but no filler. In particular, the thermal window of sample BM3 was about 22.5° C. and thermal window of sample BM6 was about 18.75° C., while the thermal window of comparative sample BM5 was about 11.5° C.

### Example 2

The six samples (BM1, BM2, BM3, BM4, BM5, BM6) prepared in Example 1 were used in Example 2. Each of the six samples was tested to determine the effect of the presence of the filler on the mechanical properties of the build material composition. To briefly summarize the results, the tests showed that there was a slight, but insignificant, change to the mechanical properties of the thermoplastic polyurethane for the samples containing the filler (BN1, BN3, BN4, BN6) compared to the comparative samples containing no filler (BN2, BN5). This means that neither of the fillers had a notable effect on the integrity of the thermoplastic polyurethane.

### Younq's Modulus

Young's modulus, or the modulus of elasticity, is a mechanical property of a material that measures the tensile or compressive stiffness of the material when a force is applied lengthwise. In essence, the Young's modulus is an indicator of how easily a material can stretch and deform. The Young's modulus for each of the samples BM1, BM2, BM3, BM4, BM5, BM6 was determined using the tensile pull method (ASTM 680).

The Young's Modulus for each of the samples BM1, BM2, BM3, BM4, BM5, BM6 is shown in the bar graph depicted in FIG. 8. As shown, the modulus of the build material samples containing the filler (BN1, BN3, BN4, BN6) was determined to be from about 65 MPa to about 80 MPa, while the comparative samples (BN2, BN5) was determined to be from about 60 MPa to about 80 MPa. Thus, the Young's modulus of the samples including the filler remained about the same as the Young's modulus of the comparative samples.

### Elongation at Break

The elongation at break, also known as fracture strain, is a property of a material that shows the resistance of a material to change shape or break formation.

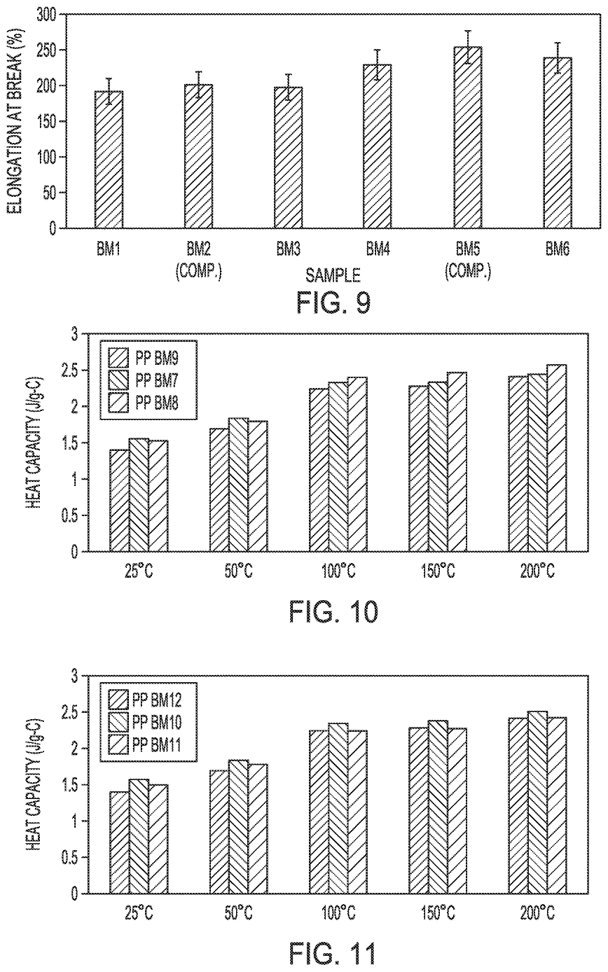

The elongation at break for each of the samples BM1, BM2, BM3, BM4, BM5, BM6 is shown in the bar graph depicted in FIG. 9. As shown, the elongation at break of the build material samples containing the filler (BN1, BN3, BN4, BN6) was determined to be from about 200% to about 230%, while the elongation at break of the comparative samples (BN2, BN5) was determined to be from about 190% to about 225%. Thus, the elongation at break of the samples including the filler remained about the same as the elongation at break of the comparative samples.

### Example 3

In this example, polypropylene was used as the base of the build material compositions, and thus all of the samples were comparative samples (as they did not include thermoplastic polyurethane particles).

Six samples of polypropylene based build material compositions (PPBM7 through PPBM12) were prepared. Polypropylene powder was used for all six samples. The build material compositions PPBM7 and PPBM8 were respectively prepared by mixing 95 wt % of the polypropylene powder 5 wt % of cubic boron nitride (having 99.99% purity) to form a dry blend. The build material compositions PPBM10 and PPBM11 were respectively prepared by mixing 95 wt % of the polypropylene powder with 5 wt % of diamond-like carbon to form a dry blend. The build material compositions PPBM9 and PPBM12 each consisted of the polypropylene powder (i.e., 100 wt % polypropylene powder without any added filler).

### Heat Capacity

The thermal stability of all six comparative samples (PPBM7-PPBM12) was tested using differential scanning calorimetry (DSC). This test is an analytical technique that measures the heat capacity of the sample as a function of temperature. Carried out in a differential scanning calorimeter, the test involved introducing heat energy into a sample cell (containing the respective comparative samples) and a blank reference cell simultaneously while identically increasing the temperature of both cells over time. Due to the difference in the compositions of the particular comparative sample and a blank reference, a different amount of energy is required to raise the temperature of the cells. The excess amount of energy required to compensate for the temperature difference between the cells is measured as the heat capacity as a function of temperature. The heat capacity was tested at the following temperatures: 25° C., 50° C., 100° C., 150° C., and 200° C., and the results are set forth in the graphs depicted in FIG. 10 (PPBM7-PPBM9) and FIG. 11 (PPBM10-PPBM12). The results in FIGS. 10 and 11 respectively show that the addition of cubic boron nitride and diamond-like carbon to polypropylene powder results in little to improvement in the thermal conductivity of polypropylene powder.

It is to be understood that the ranges provided herein include the stated range and any value or sub-range within the stated range. For example, a range from about 90 wt % to about 99 wt % should be interpreted to include not only the explicitly recited limits of about 90 wt % to about 99 wt %, but also to include individual values, such as 95 wt %, 91.5 wt %, 97 wt %, 97.25 wt %, etc., and sub-ranges, such as from about 90.5 wt % to about 98 wt %, from about 92 wt % to about 97 wt %, etc. Furthermore, when “about” is utilized to describe a value, this is meant to encompass minor variations (up to +/−10%) from the stated value.

Reference throughout the specification to “one example,” “another example,” “an example,” and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a,” “an,” and “the” include plural referents unless the context clearly dictates otherwise.

While several examples have been described in detail, it is to be understood that the disclosed examples may be modified. Therefore, the foregoing description is to be considered non-limiting.

What is claimed is:

1. A build material composition for three-dimensional printing, comprising:
thermoplastic polyurethane particles present in an amount of from about 90 wt % to about 99 wt %, based on a total weight of the build material composition; and
a thermally conductive filler present in an amount of from about 1 wt % to about 10 wt %, based on the total weight of the build material composition, the thermally conductive filler being selected from the group consisting of cubic boron nitride and diamond-like carbon.

2. The build material composition as defined in claim 1 wherein the thermally conductive filler is present in an amount of from about 4 wt % to about 6 wt %, based on the total weight of the build material composition.

3. The build material composition as defined in claim 1 wherein the thermally conductive filler includes thermally conductive nanoparticles, and the build material composition is a dry blend of the thermoplastic polyurethane particles and the thermally conductive nanoparticles.

4. The build material composition as defined in claim 3 wherein:
the thermally conductive nanoparticles are cubic boron nitride nanoparticles having an average particle size of from about 70 nm to about 800 nm; or
the thermally conductive nanoparticles are diamond-like carbon nanoparticles having an average particle size of from about 80 nm to about 600 nm.

5. The build material composition as defined in claim 1 wherein the build material composition is free of any additional components.

6. The build material composition as defined in claim 1 wherein the build material composition exhibits improved thermal properties by inclusion of the thermally conductive filler without altering the chemistry of the thermoplastic polyurethane particles compared to a build material containing thermoplastic polyurethane particles alone.

7. A thermally conductive agent for three-dimensional printing, comprising:
an aqueous vehicle; and
a thermally conductive filler dispersed in the aqueous vehicle, the thermally conductive filler being present in an amount of from about 1 wt % active to about 10 wt % active, based on a total weight of the thermally conductive agent, and the thermally conductive filler being selected from the group consisting of cubic boron nitride and diamond-like carbon.

8. The thermally conductive agent as defined in claim 7 wherein the thermally conductive filler includes thermally conductive nanoparticles that are self-dispersed.

9. The thermally conductive agent as defined in claim 8 wherein the self-dispersed thermally conductive nanoparticles include the thermally conductive nanoparticles and an organic group attached to the thermally conductive nanoparticles, the organic group selected from the group consisting of a phosphorus-containing group, a carboxylic group, and a sulfonic group.

10. The thermally conductive agent as defined in claim 8 wherein the thermally conductive filler is present in an amount of from about 4 wt % active to about 6 wt % active, based on the total weight of the thermally conductive agent.

11. The thermally conductive agent as defined in claim 10 wherein:
the thermally conductive filler particles are cubic boron nitride particles having an average particle size of from about 70 nm to about 800 nm; or
the thermally conductive nanoparticles are diamond-like carbon particles having an average particle size of from about 80 nm to about 600 nm.

12. The thermally conductive agent as defined in claim 8 wherein the aqueous vehicle includes a co-solvent, a surfactant, and an additive selected from the group consisting of an anti-kogation agent, an antimicrobial agent, a pH buffer, and combinations thereof.

13. A three-dimensional (3D) printed article, comprising:
a coalesced thermoplastic polyurethane particles present in an amount of from about 90 wt % to about 99 wt %, based on a total weight of the 3D printed article;
a thermally conductive filler intermingled throughout the coalesced thermoplastic polyurethane particles, the thermally conductive filler present in an amount of from about 1 wt % to about 10 wt %, based on a total weight of the 3D printed article and the thermally conductive filler being selected from the group consisting of cubic boron nitride and diamond-like carbon; and
an energy absorber intermingled throughout the coalesced thermoplastic polyurethane particles.

14. The 3D printed article as defined in claim 13 wherein the thermally conductive filler is cubic boron nitride present in an amount of 5 wt %, based on the total weight of the 3D printed article.

15. The 3D printed article as defined in claim 13 wherein the thermally conductive filler is diamond-like carbon present in an amount of 5 wt %, based on the total weight of the 3D printed article.
